(19) United States
(12) Patent Application Publication
(10) Pub. No.: US 2024/0329935 A1
(43) Pub. Date: Oct. 3, 2024

(54) RANDOM NUMBER GENERATION

(71) Applicant: Crypta Labs Limited, London (GB)

(72) Inventor: Jose Luis Garcia Coello, London (GB)

(73) Assignee: Crypta Labs Limited, London (GB)

(21) Appl. No.: 18/203,592

(22) Filed: May 30, 2023

(30) Foreign Application Priority Data
Mar. 31, 2023 (GB) 2304867.1

(51) Int. Cl. G06F 7/58

(52) U.S. Cl. CPC G06F 7/588

(57) ABSTRACT

A random number generator comprising a light source (7) configured to emit photons (10) throughout a light emission time interval, a photosensor (12) configured to absorb photons emitted from the light source throughout a light absorption time interval concurrent with the light emission time interval thereby to generate a continuous electrical output signal (13) extending throughout the absorption time interval, and a processor (14) configured to determine temporal variations in the continuous electrical output signal and to generate therefrom one or more quantum random numbers (15).

This application claims priority from earlier application number GB2304867.1 filed 31 Mar. 2023, the contents and elements of which are herein incorporated by reference for all purposes.

### FIELD OF THE INVENTION

The present invention relates to random number generation.

### BACKGROUND

Random numbers have important applications in cryptography. Quantum systems are at least in principle an ideal source of entropy for use in generating random numbers due to the inherent randomness at the core of quantum mechanics. Random numbers generated using entropy of quantum origin are known as quantum random numbers, and quantum random number generation (QRNG) is branch of quantum technology. The different methods employed in quantum random number generation each uses its own technique to gather entropy from a quantum origin.

Noise in electronic circuits is one of the preferred sources of entropy in classical random number generators. Noise in these systems arises from shot noise, or Schottky noise, and from thermal noise, or Johnson-Nyquist noise. Electronic shot noise refers to time-dependent fluctuations in an electrical current. This is a direct consequence of the particle-like nature of the electron, namely, the electron's discreteness and the stochastic nature of its transport through the conductor. This type of noise is not well separated from thermal noise. It is subject to many environmental fluctuations and can show memory effects. This makes it unsuitable as a source of entropy for generating random numbers.

Some existing QRNG methods are based on quantum optics. These methods include techniques based on binary decisions in single-photon detection processes. Here, a single-photon emitter device emits photons one-at-a-time. These individual photons are then detected by a single-photon detector. The variance in the arrival times of successive photons at the single-photon detector may serve as a source of entropy. Alternatively, each photon may be forced to take one of two branching paths defined by an optical beam splitter. The path taken by each single photon at the beam splitter may be detected and the random nature of the path selection may provide the entropy source. Another method of quantum random number generation exploits the fluctuations in the quantum vacuum state using a homodyne detection process once more requiring a branching optical path and two sensitive photon detectors. However, single photon emitters are expensive. In addition, single photon detectors have limited photon counting capabilities, and they too are expensive.

Yet other examples function by using an array of image sensors in an image sensor chip to sample an electromagnetic field. This produces a spatial array of concurrent time-discrete field samples distributed in space. Variation in the spatial distribution of the concurrent discrete samples is used as a source of entropy for generating random numbers.

The present invention has been devised in light of the above considerations.

### SUMMARY OF THE INVENTION

### Quantum Noise

The inventors have realised that an efficient way to generate truly random numbers is to exploit the properties of Quantum Mechanics to extract entropy from random temporal variations in observations of an electromagnetic quantum field observed continuously throughout an interval of time. In a famous paper published in 1935, Einstein, Podolsky and Rosen (EPR) hypothesised a thought experiment with which they claimed to show that Quantum Theory is an incomplete theory of Nature and that undiscovered “hidden variables” must have existed to explain the predictions of Quantum Theory. Today, however, it is known that EPR were wrong, and that Quantum Theory is a complete theory without “hidden variables”.

Repeated identical measurements of a given quantum state (or of an ensemble of many copies of the state) inherently result in a spread in the value of the measured quantity, Q, however accurate the measurements may be. The spread of measured values scatter around a mean value, [symbol] Q [symbol] , with a scatter that has a range quantifiable by its standard deviation \sqrt{ [symbol](ΔQ)² [symbol]}=\sqrt{ [symbol](Q− [symbol] Q [symbol] )² [symbol]}=\sqrt{ [symbol]Q² [symbol] − [symbol] Q [symbol] ²}. This scatter range is the quantum uncertainty of the measured quantity. This scatter is truly random because Quantum Theory is a complete theory and does not possess “hidden variables” that could cause a particular value of the measured quantity, Q, to occur.

Without wishing to be bound by theory, the inventors provide a discussion below that may offer a better understanding of the invention, the nature of quantum noise in an electromagnetic field, and insights as to the benefits provided by the invention which aims to generate such quantum noise and then to use that quantum noise to generate quantum random numbers.

### The Uncertainty Principle and Quantum Noise

One of the unique properties of quantum mechanics relates to the unavoidable uncertainty in simultaneous measurement of the position (x) and momentum (p) of a particle. Quantum mechanics shows that the product of the uncertainties Δp and Δx must obey:

$$Δ p Δ x \geq ℏ / 2$$

Where h is Planck's constant and [symbol] =h/2π. These uncertainties extend to optical measurements such as measurements of the amplitudes of optical fields.

A full quantum mechanical description of optical fields is probably not necessary or appropriate for the discussion, however the discussion that follows does illustrate the consequences of the uncertainty principle using valid approximations explains explained herein and bearing in mind that the uncertainty principle is one of the foundational consequences of quantum mechanics.

### The Uncertainty Principle

Consider a monochromatic electromagnetic field in a given field mode in a volume of space (e.g., a resonator, or the like). One may represent the electric field component, e(t), of the electromagnetic field classically as follows:

$$e ( t ) = \vert E \vert cos ( ω t + β ) = R e [ E \times exp ( i ω t ) ] \qquad Eq . 1$$

Here, β is a phase angle and:

$$E = \vert E \vert exp ( i β ) = {E}_{1} + i {E}_{2} \qquad Eq . 2$$

This quantity is the complex phasor representing the electric field. According to quantum mechanics, the complex amplitude |E| cannot be specified exactly. This causes an uncertainty schematically represented in FIG. 1A which represents the uncertainty as an uncertainty circle 2. The most probable position of the tip of the phasor E, when measured, will be found near the centre of the circle and is extremely unlikely to be found outside of it. The phasor does not represent the spatial direction of the field vector but, instead, it represents the relationship between the in-phase (real) component and the quadrature (Imaginary) component of the complex field amplitude. The field phasor 1 corresponding to the centre of this circle is denoted <E> and is the expectation value of E. This expectation value corresponds to the quantum mechanical ensemble average, in other words, the average of a large number of independent field measurements performed under identical conditions.

Repeated measurements of the projections of E, namely E₁ and E₂, will yield different results and this results in an expectation value for E=E₁+iE₂ in the form [symbol] E [symbol] = [symbol] E₁ [symbol] +i [symbol] E₂ [symbol] . The results will tend to cluster around the centre of the circle which is a graphical way to describe the most probable region in which the tip of E will fall. The uncertainty that results from this inherent quantum-imposed spread of the values of E is “Quantum Noise”.

A classical approximation of quantum physics is to represent the monochromatic field of an electromagnetic mode as:

$$e ( t ) = R e [ E ( t ) \times exp ( i ω t ) ] = {E}_{1} ( t ) cos ( ω t ) - {E}_{2} ( t ) sin ( ω t ) \qquad Eq . 3$$

where the complex amplitude E(t) is:

$$E = {E}_{1} ( t ) + i {E}_{2} ( t ) \qquad Eq . 4$$

Here one can consider electromagnetic fields that are classical analogies of quantum coherent states (e.g., as output by an ideal laser), at least to an acceptable approximation of quantum coherent states. Since the complex amplitude cannot be specified exactly, according to quantum mechanics, one may treat E(t) as a random complex variable. This means that one may write E₁(t) and E₂(t) as follows:

$${E}_{1} ( t ) = 〈 {E}_{1} ( t ) 〉 + δ {E}_{1} ( t ) = {E}_{10} ( t ) + δ {E}_{1} ( t ) \qquad Eq . 5$$

$${E}_{2} ( t ) = 〈 {E}_{2} ( t ) 〉 + δ {E}_{2} ( t ) = {E}_{20} ( t ) + δ {E}_{2} ( t )$$

Here [symbol] E₁(t) [symbol] =E₁₀(t) is the expectation value of E₁(t), [symbol] E₂(t) [symbol] =E₂₀(t) is the expectation value of E₂(t), and δE₁(t) and δE₂(t) is each a random variable representing the fundamental quantum mechanical uncertainties. They each have zero mean: [symbol] δE₁(t) [symbol] =0 and [symbol] δE₂(t) [symbol] =0 and they are uncorrelated: z,44 δE₁(t)δE₂(t) [symbol] =0. Here the angular bracket symbols “< . . . >” indicate ensemble averaging.

The mean electric field of an electromagnetic field mode is related to the mean number, n, of optical photons in that mode. Assuming the mode volume to be V, and denoting the dielectric constant of the medium containing the electromagnetic field mode as ε, the time average energy density of the electromagnetic field mode is given by:

$$\frac{ε}{2} {\vert E \vert}^{2} V = \frac{ε}{2} {( {E}_{10}^{2} + {E}_{20}^{2} )}^{2} V = n ℏ ω \qquad Eq . 6$$

This means that the mean field amplitude can be expressed in terms of the mean photon number, n, as:

$$\vert E \vert = \sqrt{( {E}_{10}^{2} + {E}_{20}^{2} )} = {( \frac{2 ℏ ω}{ε V} )}^{1 / 2} \sqrt{n} ≡ A \sqrt{n} \qquad Eq . 7$$

Here the quantity A is given by:

$$A = {( \frac{2 ℏ ω}{ε V} )}^{1 / 2} \qquad Eq . 8$$

This represents the absolute magnitude of the electric field amplitude for a single photon with energy [symbol] ω Inside a space of volume V. The mean electric field amplitude is proportional to the square root of the mean photon number, n. One may define the measure of the fundamental quantum mechanical uncertainties as:

$$Δ {E}_{1} = {〈 {( {E}_{1} - {E}_{10} )}^{2} 〉}^{1 / 2} = {〈 {( δ {E}_{1} ( t ) )}^{2} 〉}^{1 / 2} \qquad Eq . 9$$

$$Δ {E}_{2} = {〈 {( {E}_{2} - {E}_{20} )}^{2} 〉}^{1 / 2} = {〈 {( δ {E}_{2} ( t ) )}^{2} 〉}^{1 / 2}$$

According to quantum mechanics:

$$Δ {E}_{1} Δ {E}_{2} \geq \frac{{A}^{2}}{4} \qquad Eq . 10$$

In other words, a simultaneous measurement of the in-phase component, E₁, and the quadrature component, E₂, of the electric field must obey the uncertainty principle. By normalising Eq. 10, one arrives at an expression for the photon number amplitude:

$$Δ ( {E}_{1} / A ) Δ ( {E}_{2} / A ) = Δ {x}_{1} Δ {x}_{2} \geq \frac{1}{4} \qquad Eq . 11$$

Here x₁ and x₂ are dimensionless numbers and:

$$x ≡ \frac{E}{A} = \frac{{E}_{1}}{A} + i \frac{{E}_{2}}{A} = {x}_{1} + {ix}_{2} \qquad Eq . 12$$

This is a complex random number representing the photon number amplitude in the electromagnetic field. Eq. 10 applies to all field modes, n, including the n=0 field mode which, classically speaking, is the case when a field mode is not excited, such that [symbol] E₁ [symbol] = [symbol] E₂ [symbol] =0. It is known as the “vacuum state” and is purely quantum in origin and can be imagined visually by placing the ‘uncertainty circle’ 2 of FIG. 1A at the origin of coordinates. This is shown in FIG. 1B, with a repositioned uncertainty circle 3. From Eq. 5, one may write:

$$δ E ( t ) = δ {E}_{1} ( t ) + i δ {E}_{2} ( t ) \qquad Eq . 13$$

In other words, the random error δE(t)=E(t)− [symbol] E(t) [symbol] in the random vector E of FIG. 1A can be thought of as a random vector: δE₁(t)+iδE₂(t) positioned at the tip of the stationary vector <E> of length L, as follows:

$$E ( t ) = L + \vert l \vert cos ( α ) + i \vert l \vert sin ( α ) \qquad Eq . 14$$

The random error vector, which is positioned at the tip of the stationary vector <E>, has a random amplitude l and a random phase α. The amplitude, l, of the complex random phasor is responsible for the quantum fluctuations, and the value of the quantity L is the mean value of the complex field amplitude, i.e., L≡<E>. The expected value of the random error vector, of amplitude, l, is given by:

$${〈 {\vert l \vert}^{2} 〉}^{1 / 2} = {〈 {( δ {E}_{1} ( t ) )}^{2} 〉}^{1 / 2} + {〈 {( δ {E}_{2} ( t ) )}^{2} 〉}^{1 / 2} = 2 {〈 {( δ {E}_{1} ( t ) )}^{2} 〉}^{1 / 2} = \frac{{A}^{2}}{2} \qquad Eq . 15$$

### The Energy of an Electromagnetic Mode

Quantum states of light comprise a superposition of photon number states.

The energy, U, of an electromagnetic field E is given classically by:

$$U = \frac{ε}{2} {\vert E \vert}^{2} V \qquad Eq . 16$$

Because E is a random variable, the energy of the electromagnetic field is also a random variable. The mean value of the field energy may be written as:

$$〈 U 〉 = \frac{ε}{2} V 〈 {\vert L + \vert l \vert cos ( α ) + i \vert l \vert sin ( α ) \vert}^{2} 〉 = \frac{ε}{2} V ( {L}^{2} + 〈 {\vert l \vert}^{2} 〉 ) = \frac{ε}{2} V ( {A}^{2} n + \frac{{A}^{2}}{2} ) = ℏω ( n + \frac{1}{2} ) \qquad Eq . 16$$

In a situation when the classical field is zero, such that <E> and n are zero, the mode energy is [symbol] ω/2. This is the “zero-point” vibrational energy of the electromagnetic field mode. This is one of the main consequences of quantum mechanics and it does not have any classical counterpart. The only assumption used in this derivation of the “zero-point” fluctuation is the Heisenberg uncertainty principle.

### Uncertainty in Energy

Because the electric field energy is a random variable. The uncertainty (the variance) of the electromagnetic field mode energy can be defined by:

$$〈 {( Δ U )}^{2} 〉 = 〈 {( U - 〈 U 〉 )}^{2} 〉 = 〈 {U}^{2} 〉 - {〈 U 〉}^{2} \qquad Eq . 17$$

Substituting into this formula the expressions given by Eq. 14 for the random variable E(t), and Eq. 16, and noting that [symbol] cos^{m}(α) [symbol] =0 for odd values of m, and considering terms no higher than L² and |l|², it is possible to show that:

$$Δ U ≡ {〈 {( Δ U )}^{2} 〉}^{\frac{1}{2}} = ℏ ω \sqrt{n} \qquad Eq . 18$$

This expresses the uncertainty (the variance) of the electromagnetic field mode energy in terms of its mean photon number, n. It is also interesting to note that this result shows that the uncertainty (the variance) of the electromagnetic field mode energy is directly proportional to the energy of each photon, [symbol] ω. The inventors have realised that this may be exploited to beneficial effect when generating quantum random numbers, as is discussed in more detail below.

Considering this result in terms of the uncertainty, ΔN, in the number of photons, N, in the volume of space (e.g., a resonator, or the like) within which the electromagnetic field modes exist, one may write: ΔN≡ [symbol] (N−n)² [symbol] ^{1/2} such that:

$$Δ N = \frac{Δ U}{ℏ ω} = \sqrt{n} ≡ \sqrt{〈 N 〉} \qquad Eq . 19$$

$${( Δ N )}^{2} = 〈 N 〉 = n$$

In other words, the mean squared uncertainty in the number of photons in the volume of space (e.g., a resonator, or the like) is simply equated to the uncertainty in the number of photons in the electromagnetic field mode. This relationship between the mean square uncertainty, (ΔN)², in the number of photons N, and the average number of photons, [symbol] N [symbol] , is consistent with a Poisson probability distribution of the photon number, N;

$$p ( N , n ) = \frac{{n}^{N}}{N !} {e}^{- n} \qquad Eq . 20$$

This quantifies the probability of observing/finding N photons in the volume when the volume of space (e.g., a resonator, or the like) supports an electromagnetic field with an average number of photons, n.

### Fluctuation of Photoelectron Number

If an electromagnetic wave is incident on perfect photosensor whose area is A_{Det}, then for each incident photon that is absorbed, one photoelectron is emitted. The resulting photodetection current is then:

$$i = \frac{ec ε {\vert E \vert}^{2} {A}_{D e t}}{2 ℏ ω} \qquad Eq . 21$$

Here, e is the absolute value of the electron charge. The incident optical power at the detector is then:

$$P = \frac{c ε {\vert E \vert}^{2} {A}_{D e t}}{2} \qquad Eq . 22$$

Because E is a complex random variable, the electric photosensor current is also a complex random variable. Writing the photodetection current in terms of the photon number amplitude of Eq. 12, x=x₁+ix₂, one may write:

$$i = \frac{e c {A}_{D e t}}{V} ( {x}_{1}^{2} + {x}_{2}^{2} ) = \frac{e c {A}_{D e t}}{V} ( {x}_{10}^{2} + {x}_{20}^{2} + 2 {x}_{10} Δ {x}_{1} + 2 {x}_{20} Δ {x}_{2} ) = {i}_{0} + Δ i \qquad Eq . 23$$

Here we define the random vectors:

$${x}_{1} = {x}_{10} + Δ {x}_{1} ; {x}_{2} = {x}_{20} + Δ {x}_{2} \qquad Eq . 24$$

$${x}_{10} = \frac{{E}_{10}}{A} ; {x}_{20} = \frac{{E}_{20}}{A}$$

$$Noting that : ( {x}_{10}^{2} + {x}_{20}^{2} ) = \frac{{\vert 〈 E 〉 \vert}^{2}}{{A}^{2}} = n$$

the mean photocurrent is given by:

$${i}_{0} = \frac{e c {A}_{D e t}}{V} ( {x}_{10}^{2} + {x}_{20}^{2} ) = \frac{e c {A}_{D e t}}{V} n \qquad Eq . 25$$

The fluctuation in the photocurrent, about the mean value, is then given by:

$$Δ i = 2 \frac{e c {A}_{D e t}}{V} ( {x}_{10} Δ {x}_{1} + {x}_{20} Δ {x}_{2} ) \qquad Eq . 26$$

The total number of photoelectrons generated in a detection time interval

$$τ = \frac{V}{c {A}_{Det}}$$

is given by:

$${N}_{e} = \frac{i τ}{e} = ( {i}_{0} + Δ i ) \frac{τ}{e} = ( {i}_{0} ) \frac{τ}{e} + ( Δ i ) \frac{τ}{e} \qquad Eq . 27$$

The detection time interval may be considered to be a light absorption time interval (i.e., continuous in time) by the detector material (e.g., Silicon, such as a photodiode). The average number of photoelectrons generated in a detection time interval is then given by:

$$〈 {N}_{e} 〉 = \frac{{i}_{0} τ}{e} = n \qquad Eq . 28$$

This is exactly the mean photon number of the electromagnetic modes. Noting that:

$$\begin{matrix}〈 Δ {x}_{1} Δ {x}_{2} 〉 = 0 \\ 〈 {( Δ {x}_{1} )}^{2} 〉 = 〈 {( Δ {x}_{2} )}^{2} 〉 = 1 / 4 \\ 〈 Δi 〉 = 0\end{matrix}$$

one may calculate the variance in the number of photoelectrons generated in the detection time interval as:

$$〈 Δ {N}_{e}^{2} 〉 = \frac{〈 {( Δ i )}^{2} 〉 {τ}^{2}}{{e}^{2}} = 4 〈 {( {x}_{10} Δ {x}_{1} + {x}_{20} Δ {x}_{2} )}^{2} 〉 = 4 [ 〈 {x}_{10}^{2} 〈 {( Δ {x}_{1} )}^{2} 〉 + {x}_{20}^{2} 〈 {( Δ {x}_{2} )}^{2} 〉 〉 ] = 4 ( {x}_{10}^{2} + {x}_{20}^{2} ) 〈 {( Δ {x}_{1} )}^{2} 〉 = n \qquad Eq . 29$$

This shows us that:

$$〈 Δ {N}_{e}^{2} 〉 = 〈 {N}_{e} 〉$$

Consequently, the variance on the number of photoelectrons generated by the detector in the detection time interval when in the presence of an electromagnetic field in a coherent state (or an acceptable approximation to that state), is equal to the mean number of photoelectrons generated in that time interval. In this way, the Poisson probability distribution of the photon number, N, defined by Eq. 20, is imprinted upon the probability distribution of the photoelectron number, Nₑ, as:

$$p ( {N}_{e} , 〈 {N}_{e} 〉 ) = \frac{{〈 {N}_{e} 〉}^{{N}_{e}}}{( {N}_{e} ) !} {e}^{- 〈 {N}_{e} 〉} = p ( {N}_{e} , n ) = \frac{{n}^{{N}_{e}}}{( {N}_{e} ) !} {e}^{- n} \qquad Eq . 30$$

This quantifies the probability of generating Nₑ photoelectrons when “observing” a volume that supports an electromagnetic field with an average number of photons, n. This photocurrent noise can therefore be attributed to quantum field fluctuations. It is a measure of “Quantum Noise”.

### Properties of “Quantum Noise”

Quantum uncertainty relates to so-called “ensemble” measurements using many copies of the system of interest. The following conditions apply:
(1) All copies must be in the same quantum state;
(2) The measurements must be identical; and,
(3) The measurements must be able to resolve the spread of quantum uncertainty.

In spite of the identical copies required by (1), the outcome of the individual identical measurements noted in (2) will deviate from each other. The scatter range noted at (3) is the quantum uncertainty/noise and is quantified by the standard deviation (or variance) in the repeated measurements.

### Poisson Noise that is Not “Quantum Noise”

It is to be noted that the discussion of “Quantum Noise” given above assumes that the photosensor is perfect (e.g., has an internal quantum efficiency, IEQ, of 1.0). The discussion and its conclusions may be less relevant when the efficiency of the photosensor is not high enough. The reasons are as follows.

### Thermal Light and Poisson Statistics

A thermal light source produces a photon spectrum characterised by a Planck distribution which arises because the probability of there being n photons in a given field mode follows Boltzmann's law:

$$P ( n ) = \frac{exp ( - {E}_{n} / kT )}{{\sum }_{n = 0}^{∞} exp ( - {E}_{n} / kT )} \qquad Eq . 31$$

When Eₙ=(n+1/2) [symbol] ω, this reduces to the Bose-Einstein distribution:

$$P ( n ) = \frac{1}{\overline{n} + 1} {( \frac{\overline{n}}{\overline{n} + 1} )}^{n} \qquad Eq . 32$$

The variance of the photon number is defined by:

$$Var ( n ) ≡ {( Δ n )}^{2} = {\sum }_{n = 1}^{∞} {( n - \overline{n} )}^{2} P ( n ) \qquad Eq . 33$$

Substituting Eq.32 into Eq.33 gives:

$${( Δ n )}^{2} = \overline{n} + {\overline{n}}^{2} \qquad Eq . 34$$

Clearly, when n̅ is large, one can see that (Δn)²≈n̅² which is what one would expect—namely, that the noise (variance) from a thermal light source scales quadratically with the power of the source. However, this applies to a single given field mode. When one considers thermal light as comprising Nₘ thermal modes of similar frequency then Eq. 34 becomes:

$${( Δ n )}^{2} = \overline{n} + \frac{{\overline{n}}^{2}}{{N}_{m}} \qquad Eq . 35$$

Thus, as Nm becomes large, then (Δn)²≈n̅ and Poisson statistics in the photons re-appear even though the noise is not “Quantum Noise”.

### Imperfect Photosensors

Consider the following result for photoelectron counting statistics by an imperfect photosensor. If the photodetector has an internal quantum efficiency (IEQ) denoted η, and a variance in the photoelectron count by that photosensor is (ΔN)² over a given detection time interval, and if the corresponding variance in the number of photons hitting the detector is (Δn)² over that same time interval, then it can be shown that:

$${( Δ N )}^{2} = {{η}^{2} ( Δ n )}^{2} + η ( η - 1 ) \overline{n} ; η = \overline{N} / \overline{n} \qquad Eq . 36$$

From Eq. 36, one can see that if the detector is perfect, and η=1, then ΔN=Δn. This means that the photoelectron variance faithfully reproduces the photon variance. Of course, the better the detector (i.e., η≈1) then the more closely will the photoelectron variance approximate the photon variance. However, if the photosensor is of low efficiency, such that n«1, then the photoelectron statistics will become Poissonian (with (ΔN)²˜N̅) irrespective of the actual underlying statistics of the photons. Poisson statistics in the photoelectrons re-appear even though the noise is not “Quantum Noise”. This means that there may be two ways in which a photoelectron variance may appear to have the properties of Poisson statistics but is not the result of “Quantum Noise” in a photon field. The first may be when the light source is “thermal” in the sense that it obeys Planck's blackbody radiation law and has many thermal modes (cf. Eq. 35). The second may be when the photosensor has poor efficiency (cf. Eq. 36).

The inventors have found that it is possible to extract “Quantum Noise” from within a photon field using relatively inexpensive apparatus that is amenable to mass-production. This permits a low-cost random number generator able to generate random numbers using “Quantum Noise” to provide what is known in the art as a “Quantum Random Number”. Aspects of the invention as disclosed below, and these may be considered in the light of the discussion and observations set out above, for a better understanding of the invention.

In a first aspect, the invention may provide a random number generator comprising: a light source configured to emit photons throughout a light emission time interval; a photosensor configured to absorb photons emitted from the light source throughout a light absorption time interval concurrent with the light emission time interval thereby to generate a continuous electrical output signal extending throughout the absorption time interval; and a processor configured to determine temporal variations in the continuous electrical output signal and to generate therefrom one or more quantum random numbers.

In this way, the invention provides a way to generate quantum noise in an electromagnetic field which may be easily and reliably extracted from the electromagnetic field, and then to use that quantum noise to generate quantum random numbers. By providing a continuous electrical output signal corresponding to a continuous light absorption time interval, a time-continuous flow of quantum noise extracted from the electromagnetic field may be imprinted upon the time-continuous electrical output signal.

References herein to quantum random numbers may be considered to include a reference to random numbers the entropy of which is predominantly of quantum origin.

References herein to entropy may include a reference to a measurement of uncertainty in a system.

Entropy comes from an environment which is unpredictable. Entropy may be quantified in accordance with the definition provided by von Neumann, which is an extension of the concept of Gibbs entropy from classical statistical mechanics to quantum statistical mechanics. For a quantum-mechanical system described by a density matrix ρ, the von Neumann entropy, S, is given by:

$$S = - tr ( ρ ln ( ρ ) )$$

Here, “tr”, denotes the “trace” and “ln” denotes the natural matrix logarithm. Entropy according to the von Neumann definition may be linked to the information-theoretic Shannon entropy that is well known in the technical field of random numbers generation and is used to quantify how much entropy is in a random number. Shannon entropy for a binary number may be given by:

$$S = - {\sum }_{i = 1}^{n} P ( X = {x}_{i} ) {log}_{2} ( P ( X = {x}_{i} ) )$$

Here, X is a random variable and P(X=xᵢ) is the probability that this random variable has the value xᵢ, and n represents the number of distinct states that the random variable may have (i.e., n=2 in this case). For example, X may represent a binary bit string of given bit length in which there are n=2 possible values for each bit of the bit sting (i.e. x₁=0. x₂=1). Shannon's Entropy of a binary string: s=x₁, . . . , xₙ, where P(xᵢ=1)=p and P(xᵢ=0)=(1−p), is:

$$S = - p {log}_{2} p - ( 1 - p ) {log}_{2} ( 1 - p )$$

When p=0.5, as would be the case where the bit values are generated by a truly random process, as opposed to a biased process, then S=1.0 which indicates a maximum variety and a maximum entropy.

The photosensor preferably comprises a photoconductive device (e.g., a photodiode or a phototransistor) comprising a space charge layer or depletion region for the generation of photoelectrons by said photon absorption, and wherein the photosensor is configured to output the photoelectrons as said continuous electrical output signal contemporaneously as the photoelectrons are generated.

For example, the photoconductive device may comprise a p-n semiconductor structure comprising a p-n junction or may comprise a p-i-n semiconductor structure comprising a p-i-n junction. For example, a p-i-n junction (e.g., in a photodiode or phototransistor) may be considered to be analogous to a p-n junction with an intrinsic (e.g., lightly doped) semiconductor layer sandwiched between the p-type semiconductor layer and the n-type semiconductor layer. The energy band diagram for a reverse-biased p-i-n photoconductive device is similar to that of a p-n photoconductive device in that it allows a continuous flow of photoelectrons out from the photoconductive device in response to a continuous input of photons to the device. The intrinsic later of a p-i-n semiconductor structure serves to widen the space charge layer or depletion layer where the generated carriers can be transported by drift, and increases the area available for capturing photons.

A phototransistor is a light-sensitive transistor configured such that illuminating photons can reach the base-collector junction of the device. Photoelectrons generated by absorption of photons in the base-collector junction are injected into the base. This current is amplified by the transistor's current gain. The phototransistor may function as a photodiode when the base and collector terminals alone are used, and the emitter terminal remains unconnected/un-used.

The random number generator may comprise a photosensor drive circuit configured to supply power to the photosensor in a reverse bias configuration. In a reverse bias configuration may be achieved by applying a DC voltage that prevents or greatly reduces current flow in a photoconductive device of the photosensor (e.g., photodiode, phototransistor, etc.). For example, a negligible current may flow through a photoconductive device when its cathode is made more positive than its anode, and the photoconductive device is then said to be reverse biased. Electrical conduction through the device is then achieved by absorption of photons from the light source so as to create photoelectrons in proportion to the flux of photons. A continuous flux of photons may thereby provide a continuous flow of photocurrent (photoelectrons) by the photoconductive device throughout the aforesaid light absorption time interval concurrent with the light emission time interval, thereby to generate the continuous electrical output signal extending throughout the absorption time interval.

The photosensor (e.g., a photoconductive device thereof) preferably has an internal quantum efficiency (IEQ) exceeding 0.5 in respect of photons emitted by the light source. As noted above, and discussed in more detail below, this provides an advantage of enhancing the ability of the photosensor to generate a photocurrent in response to the absorption of photons which more accurately reflects the quantum noise inherent in the electromagnetic field from which the photons come.

The random number generator may comprise an optical filter configured to receive light from the light source and to transmit only a portion of the received light to the photosensor for use in generating the continuous electrical output signal, wherein the photosensor is responsive to light of wavelengths falling within a predetermined range of wavelengths, and the optical filter defines a spectral transmission characteristic configured to preferentially transmit light from the light source with wavelengths shorter than a wavelength defining the middle of the predetermined range of wavelengths. For example, the filter may be configured to have a spectral pass band centred upon a wavelength which is shorter than the centre wavelength of the spectral response characteristic of the photosensor. As a result, a greater proportion of the photons, or a majority of the photons, that enter the photosensor (e.g., the photoconductive/active part thereof) may have wavelengths shorter than the middle of the predetermined range of wavelengths defining the spectral response characteristic of the photosensor. These higher-energy photons convey a greater variance (quantum uncertainty) in their energy, as noted above by Eq. 18, and are more likely to be absorbed in the photoconductive/active part of the photosensor as discussed in more detail below. This synergy of effects may result in an enhanced amount of entropy of quantum origin while simultaneously enhancing the internal quantum efficiency, IQE, of the photosensor and, therefore, its ability to more accurately and faithfully reflect that enhanced quantum entropy within the variance of the photocurrent it generates. Another benefit of the optical filter is that it allows a relatively broad-band light source to be used which may produce an optical output spanning a relatively broad spectral (wavelength) range and, typically, may be relatively cheaper than narrow-band light sources. The effect of the optical filter is to select the relevant spectral range of photons with which to illuminate the photosensor.

As an alternative the photosensor may be responsive to light of wavelengths falling within a predetermined range of wavelengths, and the light source may be configured to emit light preferentially with wavelengths shorter than a wavelength defining the middle of the predetermined range of wavelengths. This choice of light source may be as an alternative to, or in addition to, the use of an optical filter noted above.

The optical filter in conjunction with the photosensor may have an external quantum efficiency, EQE, of less than 0.5 in respect of photons emitted by the light source. It has been found that even though a relatively low external quantum efficiency may result from the use of an optical filer, the beneficial effects of the enhancement of the internal quantum efficiency, IQE, are significant in providing random noise of quantum origin.

The random number generator may comprise a signal amplifier configured to amplify the continuous electrical output signal from the photosensor and to output the amplified continuous electrical output signal to the signal processor, wherein the signal processor is arranged to configured to determine the temporal variations as temporal variations in the amplified continuous electrical output signal. Amplification of the continuous electrical output signal from the photosensor has been found to allow more effective extraction of the quantum noise present within the signal, which tends to reside within the smaller fluctuations of the signal value. For example, when the continuous electrical output signal from the photosensor is provided in a digitised form, the quantum noise tends to reside in the fluctuations of the values of the least significant bit or bits of the digital signal value. Amplification enhances the ability of the random number generator to access this noise.

The random number generator may comprise a non-thermal light source, being a light source that produces a light output that does not obey Planck's blackbody radiation law. The random number generator may comprise a light source drive circuit configured to supply a drive current into the light source. The light source drive circuit may comprise an electrically resistive circuit component connected in series with the light source wherein the light source drive circuit is configured to apply a voltage across the electrically resistive circuit component sufficient to provide a voltage at the light source to suppress shot noise. For example, the electrically resistive circuit component may comprise a resistor or may comprise a transistor. The electrically resistive circuit component preferably has enough ohmic resistance to drop at least 50 mV across it in use. As discussed below, it can be shown that provided that the voltage dropped across the electrically resistive circuit component is greater than 50 mV, then the fluctuations in the drive current are below the shot-noise level. This helps to suppress such electronic shot noise from modulating the light output of the non-thermal light source and thereby suppresses such electronic shot noise from unduly influencing the photon statistics of the electromagnetic field created by the light source, which may thereby be predominantly originate from photon quantum noise.

The light source may comprise a light-emitting diode, LED, or a laser (e.g., a laser diode).

The random number generator preferably comprises an opaque enclosure containing the light source and the photosensor wherein the opaque enclosure is opaque to all wavelengths of light that the photosensor is photosensitive to, thereby to isolate (e.g., optically isolate) the photosensor from light sources external to the opaque housing. As a result, the photocurrent generated by the photosensor may be predominantly, or substantially only, the result of the absorption of photons emitted by the light source of the random number generator.

The processor is preferably configured to receive the continuous electrical output signal from the photosensor in an unfiltered form and to generate the one or more quantum random numbers from the unfiltered continuous electrical output signal. By being unfiltered, the continuous electrical output signal is not subject to smoothing, or removal of high-frequency signal components, or noise removal by electronic filtering components (e.g., capacitors) or signal filtering devices or circuit arrangements having an equivalent effect. The presence of noise within the continuous electrical output signal is therefore preserved for use in generating quantum random numbers.

The random number generator may comprise an analogue-to-digital converter unit for receiving the continuous electrical output signal in an analogue form and for converting the continuous electrical output signal into a digital representation comprising a plurality of bits. The processor is preferably configured to generate the quantum random numbers using a sub-set of the plurality bits which excludes at least the most significant bit of the digital representation and includes at least the least significant bit of the digital representation. As noted herein the quantum noise present within the continuous electrical output signal tends to reside within the smaller fluctuations of the signal value. When the continuous electrical output signal is provided in a digitised form, the quantum noise tends to reside in the fluctuations of the values of the least significant bit or bits of the digital signal value. Selecting these bits exclusively for use in random number generation enhances the ability of the random number generator to access this quantum noise.

Desirably, the digital representation comprises N bits, and the sub-set of the plurality bits excludes M of the most significant bits of the digital representation and includes L of the least significant bits of the digital representation, wherein N, M and L are positive integers and N=M+L. For example, L=N/2 is a preferred value for L. Thus, of the continuous electrical output signal may be digitised in a digital representation comprising 10 bits (N=10) and the sub-set of the 5 least significant bits (L=5) are then used to generate quantum random numbers. This is consistent with the observation that quantum noise can be expected to result in the standard deviation of the digitised signal of N bits being proportional to the square root of the value of that signal. That square root value would be accurately conveyed by a digital number of N/2 bits in length.

In addition, or as an alternative, the processor is preferably configured to calculate the time averaged value of one or more bits corresponding to a respective bit position within the digital representation of the continuous electrical output signal, to compare the time-averaged value(s) to a pre-set reference value and to generate the quantum random numbers using only bits corresponding to those bit positions for which the time-averaged value does exceed the reference bit value by more than a pre-set difference value. The pre-set reference value may be a value of 0.5. The pre-set difference value may be a value not exceeding 0.05. The time-averaging may comprise calculating the average of a plurality of the instantaneous bit values, for a given bit position, over an interval of time equal to (or residing within) the aforementioned light absorption time interval.

If the averaging process indicates that a bit value of 1 is equally as likely as a bit value of 0 during the time interval over which averaging took place, then the time-averaged bit value will be sufficiently close to 0.5 to indicate that the instantaneous bit value is random in nature. However, if the time-averaged bit value is too distant from a value of 0.5, then either a bit value of 1 is more likely than a bit value of 0 (or vice versa) which would be indicated by a time-averaged value which differs from 0.5 by more than (or less than) the pre-set threshold value. This would be taken to indicate that the continuous electrical output signal possesses a bias either way and the data is not truly random. Operating temperature, electrical interference and light source/sensor deterioration among others may contribute factors to the introduction of bias.

The processor may be configured to calculate the time-averaged bit value of all bit positions corresponding to only the sub-set of the plurality bits of the digital representation of the continuous electrical output signal, which excludes M of the most significant bits. Alternatively, the processor may be configured to calculate the time-averaged bit value of all bit positions corresponding to all bits of the digital representation of the continuous electrical output signal. In this way, bits may be excluded from use in generating the quantum random number based on this time-averaging process either in addition to excluding M of the most significant bits, or as an alternative to that.

The random number generator may comprise a controller configured to control the light source to adjust the intensity of light emitted from the light source to maintain the temporal variations in the continuous electrical output signal to be within a pre-set range. As noted above, the presence of quantum noise within the temporal variations in the continuous electrical output signal may be indicated by the value of the Variance of those variations being equal to the mean (e.g., time-average) value of the continuous electrical output signal. The controller may be configured to control the light source to maintain this condition; namely that the value of the Variance (or Standard Deviation, SD) differs from the mean (or √mean) value by not more than a pre-set amount (e.g., by not more than the pre-set range permits). The pre-set range is preferably a pre-set range of values of Variance of said temporal variations. The Variance referred to herein may be expressed as a Standard Deviation (i.e., the square root of that Variance). The controller may implement a condition, to within a pre-set margin of acceptable error, that the measured value of the Variance (or SD) in the statistics of the continuous electrical output signal is equal to the measured value of the Mean (or \sqrt{Mean}) in the statistics of the continuous electrical output signal, which mirrors the photon statistics.

The pre-set range in respect of a given continuous electrical output signal is preferably a range centred upon a median Variance (or median Standard Deviation, SD) which is substantially equal to the value (e.g., a mean value, such as a time-averaged value) of the continuous electrical output signal. In other words, the centre of the range (i.e., the median of the Variance range) may be equal to a value (e.g., a mean value, such as a time-averaged value) of the continuous electrical output signal with which the Variance is associated, or from which it is derived. Of course, if the variations are expressed as a Standard Deviation, then the centre of the range (i.e., the median of the SD range) may be equal to a square root of the value (√value e.g., a mean value, such as a time-averaged value) of the continuous electrical output signal with which the Standard Deviation is associated, or from which it is derived.

The controller may be configured to:
detect when the Variance (e.g., expressed as a Standard Deviation) of the temporal variations in the continuous electrical output signal are not within the pre-set range of the value of Variance;
adjust the intensity of the light emitted from the light source to one or more intensity values within a pre-set range of intensity values; and
if the Variance of the temporal variations in the continuous electrical output signal remain not within the pre-set range of the value of Variance in response to the adjusted intensity of the light emitted from the light source, to determine that a fault is present and to output a fault warning message.

The step of adjusting the intensity of the light emitted from the light source may be performed by a process including adjusting the power suppled to the light source. If the power supplied to the light source is pulse-width modulated (PWM), then this may include adjusting the duty cycle of that modulation. In this way, the controller may check whether or not the Variance (or Standard Deviation) of the temporal variations is consistent with quantum noise, at least to within acceptable errors quantified by the pre-set range. If it is found to be not within an acceptable error margin of that condition, then a fault warning message may be output.

The controller may be configured to:
control the light source to vary the intensity of light illuminating the photosensor successively with each one of a plurality of different intensities of light (e.g., thereby to sample a plurality of different discrete intensity values) therewith to generate a respective plurality of the continuous electrical output signals in response to the different respective intensities of light;
determine the Variance of each of the plurality of continuous electrical output signals, thereby providing a plurality of Variance values;
select the largest Variance value from amongst the plurality of Variance values within the pre-set range of the value of Variance; and
control the light source to illuminate the photosensor with the intensity of light corresponding to the selected Variance.

The step of adjusting the intensity of the light emitted from the light source may be performed by a process including adjusting the power suppled to the light source. If the power supplied to the light source is pulse-width modulated (PWM), then this may include adjusting the duty cycle of that modulation. In this way, the controller may find the appropriate value(s) of the control parameter(s) of the light source necessary to achieve the intensity of light emission from the light source required to produce the largest Variance (or Standard Deviation) of the temporal variations consistent with quantum noise. Of course, the ‘largest’ Variance (or Standard Deviation) means the largest value from amongst the sampled values. Therefore, the greater the number of light intensity samples, the closer the measured maximum Variance (or Standard Deviation) value is likely to be to the true maximum Variance value corresponding to the greatest quantum noise content.

The controller may be configured to monitor (e.g., periodically measure) the Variance (or Standard Deviation) of the continuous electrical output signals and to control the light source to vary the intensity of light illuminating the photosensor to maintain the Variance (or Standard Deviation) value at a pre-set target Variance (or Standard Deviation) value. The pre-set target Variance (or Standard Deviation) value may correspond to the ‘largest’ Variance (or Standard Deviation) value from amongst the sampled values.

In a second aspect, the invention may provide a method for generating a random number comprising: controlling a light source to emit photons throughout a light emission time interval; by a photon sensor. absorbing photons emitted from the light source throughout a light absorption time interval concurrent with the light emission time interval thereby to generate a continuous electrical output signal extending throughout the absorption time interval; and by a processor, determining temporal variations in the continuous electrical output signal and generating therefrom one or more quantum random numbers the entropy of which is predominantly of quantum origin.

In the method, the photosensor preferably comprises a photoconductive device (e.g., a photodiode or a phototransistor) comprising a space charge layer or depletion region for the generation of photoelectrons by said photon absorption, and the method may comprise, by the photosensor, outputting the photoelectrons as said continuous electrical output signal contemporaneously as the photoelectrons are generated.

In the method, preferably the photosensor (e.g., a photoconductive device thereof) has an internal quantum efficiency (IQE) exceeding 0.5 in respect of photons emitted by the light source. The method may comprise:
by an optical filter, receiving light from the light source so as to transmit only a portion of the received light to the photosensor for use in generating the continuous electrical output signal,
wherein the photosensor is responsive to light of wavelengths falling within a predetermined range of wavelengths, and the optical filter defines a spectral transmission characteristic configured to preferentially transmit light from the light source with wavelengths shorter than a wavelength defining the middle of the predetermined range of wavelengths.

In the method, the optical filter in conjunction with the photosensor may have an external quantum efficiency, EQE, of less than 0.5 in respect of photons emitted by the light source.

The method may comprise:
providing a signal amplifier and therewith amplifying the continuous electrical output signal from the photosensor;
outputting the amplified continuous electrical output signal to the signal processor; and,
by the signal processor, determining said temporal variations as temporal variations in the amplified continuous electrical output signal.

The method may comprise providing a photosensor drive circuit and therewith supplying power to the photosensor in a reverse bias configuration.

The method may comprise providing the light source as a non-thermal light source, being a light source that produces a light output that does not obey Planck's blackbody radiation law. The method may comprise providing a light source drive circuit and therewith supplying a drive current into the light source. In the method, the light source drive circuit may comprise an electrically resistive circuit component connected in series with the light source wherein the light source drive circuit is configured to apply a voltage across the electrically resistive circuit component sufficient to provide a voltage at the light source to suppress shot noise. For example, the electrically resistive circuit component may comprise a resistor or may comprise a transistor.

The light source may comprise a light-emitting diode, LED, or a laser.

The method may comprise providing an opaque enclosure containing the light source and the photosensor wherein the opaque enclosure is opaque to all wavelengths of light that the photosensor is photosensitive to, thereby isolating the photosensor from light sources external to the opaque housing.

The method may comprise, by the processor, receiving the continuous electrical output signal from the photosensor in an unfiltered form and generating the one or more quantum random numbers from the unfiltered continuous electrical output signal.

The method may comprise providing an analogue-to-digital converter unit and therewith receiving the continuous electrical output in an analogue form and converting the continuous electrical output into a digital representation comprising a plurality of bits, wherein the method includes, by processor, generating the quantum random numbers using a sub-set of the plurality bits which excludes at least the most significant bit of the digital representation and includes at least the least significant bit of the digital representation.

Preferably, the digital representation comprises N bits, and the sub-set of the plurality bits excludes M of the most significant bits of the digital representation and includes L of the least significant bits of the digital representation, wherein N, M and L are positive integers and N=M+L.

The method may comprise:
controlling the light source to adjust the intensity of light emitted from the light source to maintain said temporal variations in the continuous electrical output signal to be within a pre-set range.

Preferably, according to the method, the pre-set range is a pre-set range of the value of variance of said temporal variations.

Preferably, according to the method, the pre-set range in respect of a given continuous electrical output signal is a range centred upon a median variance which is substantially equal to the value of the continuous electrical output signal.

The method may comprise controlling the light source to adjust the intensity of light emitted from the light source to maintain a condition that a value of the variance of said temporal variations in the continuous electrical output signal differs from a value of the mean thereof by not more than a pre-set amount. The method may implement a condition, to within a pre-set margin of acceptable error, that the measured value of the Variance (or SD) in the statistics of the continuous electrical output signal is equal to the measured value of the Mean (or \sqrt{Mean}) in the statistics of the continuous electrical output signal, which mirrors the photon statistics.

The method may comprise:
detecting when the variance of said temporal variations in the continuous electrical output signal are not within said pre-set range of the value of variance;
adjusting the intensity of the light emitted from the light source to one or more intensity values within a pre-set range of intensity values; and if the variance of said temporal variations in the continuous electrical output signal remain not within said pre-set range of the value of variance in response to the adjusted intensity of the light emitted from the light source, determining that a fault is present and outputting a fault warning message.

The method may comprise:
controlling the light source to vary the intensity of light illuminating the photosensor successively with each one of a plurality of different intensities of light and therewith generating a respective plurality of said continuous electrical output signals in response to the different respective intensities of light;
determining the variance of each of said plurality of continuous electrical output signals, thereby providing a plurality of variance values;
selecting the largest variance value from amongst the plurality of variance values within said pre-set range of the value of variance; and
controlling the light source to illuminate the photosensor with the intensity of light corresponding to the selected variance.

In a third aspect, the invention may provide a computer or a processor or a microprocessor comprising a computer program configured to implement the method described above when executed on the computer or the processor or the microprocessor.

In a fourth aspect, the invention may provide a computer program product comprising a storage medium containing a computer program configured to implement the method described above when executed on a computer or a processor or a microprocessor when programmed according to the computer program.

The invention includes the combination of the aspects and preferred features described except where such a combination is clearly impermissible or expressly avoided.

References herein to “internal quantum efficiency”, IQE, include a reference to a ratio of the number of charge carriers (e.g., electrons) generated by a photoelectric device to the number of photons of a given energy that illuminate the device and are absorbed by the device. This may exclude photons that illuminate the device but are not absorbed by it (e.g., they are transmitted through the device and/or reflected from the device).

References herein to “external quantum efficiency”, EQE, include a reference to a ratio of the number of charge carriers (e.g., electrons) generated by a photoelectric device to the number of photons of a given energy that illuminate the device, including both those that are absorbed by the device and those that are not absorbed by the device. This may include photons that illuminate the device but are not absorbed by it (e.g., they are transmitted through the device and/or reflected from the device).

### SUMMARY OF THE FIGURES

Embodiments and experiments illustrating the principles of the invention will now be discussed with reference to the accompanying figures in which:

FIGS. 1A and 1B show schematic diagrams of a vector representing an electric field component of an electromagnetic field, including uncertainty.

FIG. 2 shows a schematic diagram of a random number generator.

FIG. 3 shows a schematic diagram of a non-thermal light source within the random number generator of FIG. 2.

FIG. 4 shows a schematic diagram of an optical emission spectrum of the non-thermal light source of FIG. 3.

FIG. 5 shows a schematic diagram of a photodetector within the random number generator of FIG. 2.

FIG. 6 shows a schematic diagram of a photodetector of FIG. 5 when in receipt of light from the non-thermal light source of FIG. 3.

FIG. 7 shows a diagram of the internal quantum efficiency, IQE, of the photodetector of FIG. 5.

FIG. 8 shows a schematic diagram of an optical module of the random number generator of FIG. 2.

FIG. 9 shows a schematic diagram of a voltage output by the photodetector of FIG. 5.

FIG. 10 shows a relationship between the value of the voltage output by the photodetector of FIG. 5 and the standard deviation (the square root of the variance) of the value of that voltage output.

FIG. 11 shows a relationship between the value of the voltage output by the photodetector of FIG. 5 and the pulse-width modulation (PWM) duty cycle of the drive voltage applied to the non-thermal light source of FIG. 3.

FIG. 12 shows a schematic diagram of the input/output timing characteristics of the optical module of FIG. 8.

FIG. 13 shows a diagram of an auto-correlation coefficient of the voltage output by the photodetector of FIG. 5.

FIG. 14 shows a schematic diagram of the random number generator of FIG. 2.

FIG. 15 shows steps in a method for generating a random number.

FIG. 16 shows steps in a method for controlling a random number generator for generating a random number.

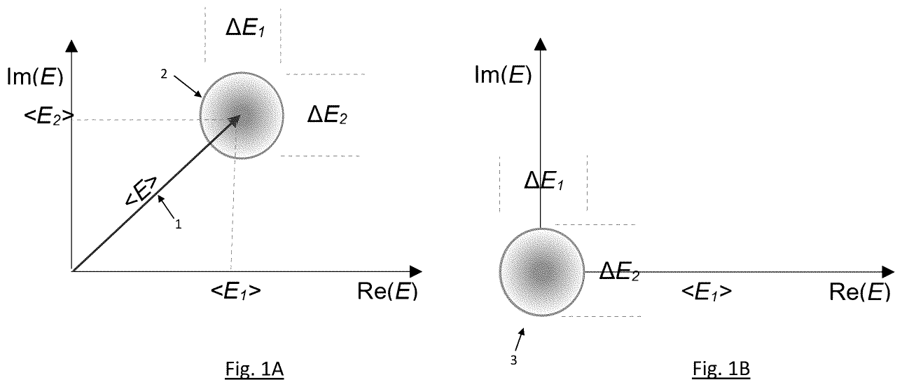

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

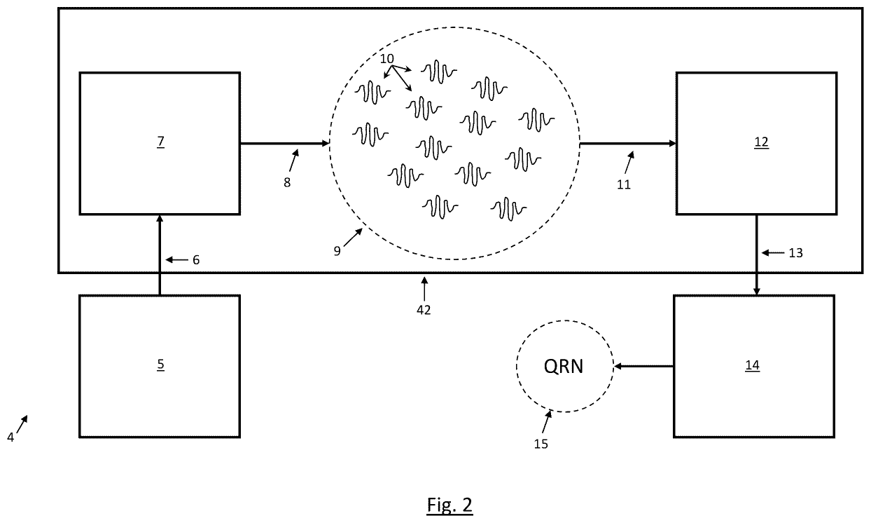

FIG. 2 illustrates schematically a random number generator 4 according to an embodiment of the invention. The random number generator comprises a power supply and control unit 5 configured to provide a controlled supply of electrical power 6 to a non-thermal light source unit 7 to cause the light source to emit a controlled output of light 8. The power supply and control unit is configured to supply a DC voltage supply to the light source unit 7 which is pulse-width modulated (PWM) according to a PWM modulation having a duty cycle controlled by the power supply and control unit. The power supply and control unit 5 is configured to generate a digital power supply control signal conveying the PWM control signal in a digital form and comprises a digital-to-analogue converter (DAC) arranged to receive the PWM control signal in the digital form and to convert the received signal into an analogue form for input to the non-thermal light source unit 7.

In addition, the amplitude of the DC voltage supply is also controlled by the power supply and control unit such that, in conjunction with control of the PWM duty cycle, the power supply and control unit may control the amount of electrical power supplied to the light source unit 7. In addition, the power supply and control unit is configured to control the duration of time for which power is supplied to the light source. In particular, the duration of time is controlled to be continuous throughout at least the duration of a pre-set the light emission time interval.

The non-thermal light source unit 7 is configured to respond to the supply of power from the power supply and control unit 5 to emit photons 10 throughout the light emission time interval. The non-thermal light source unit 7 is non-thermal in the sense that the optical output spectrum thereof does not obey Planck's radiation law. The light output 8 of the non-thermal light source creates an electromagnetic field 9 possessing field modes as discussed above. As noted in Eq. 18, above, for a field mode containing an average of n photons, 10, each of optical frequency ω, an uncertainty, ΔU, is present in the energy of the field modes according to:

$$Δ U ≡ {〈 {( Δ U )}^{2} 〉}^{\frac{1}{2}} = ℏ ω \sqrt{n}$$

The random number generator also includes a photosensor unit 12 configured to absorb photons 10 emitted from the light source throughout a light absorption time interval. The light absorption time interval is concurrent with the light emission time interval applied to the light source unit 7 by the power supply and control unit 5. Accordingly, the photosensor unit 12 is configured to respond to the electromagnetic field 9 by absorbing photons 10 thereform so as to generate photoelectrons thereby to generate a continuous electrical output signal extending throughout the absorption time interval. In this way, the photosensor unit 12 is configured to conduct a continuous sampling 11 of photons from the electromagnetic field 9 and to use those sampled photons to generate a corresponding photoelectron current which is converted into a corresponding sensor output voltage signal 13 which is a continuous electrical output signal. The inventors have found that this sampling is able to imprint upon the photoelectron current, and therefore onto the output voltage signal 13, a variance which to a significant extent corresponds to the uncertainty, ΔU, present in the energy of the field modes from which the photons 10 are sampled. As noted above, this uncertainty, ΔU, is quantum in origin and relates to Heisenberg's uncertainty relation.

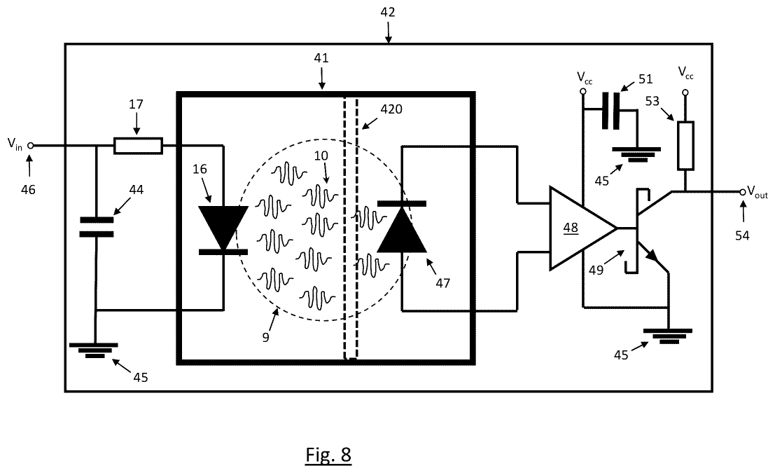

The light source unit 7 and the photosensor unit 12 are provided within a photonic module 42 which may be an integrated chip or other integrated module or unit. This is discussed in more detail below with reference to FIG. 8.

The random number generator includes a processor unit 14 configured to receive the sensor output voltage signal 13 during the light absorption time interval and to determine temporal variations in that continuous electrical output signal. The processor unit 14 is configured to use the temporal variations to generate one or more quantum random numbers, QRN, 15 the entropy of which is predominantly of quantum origin.

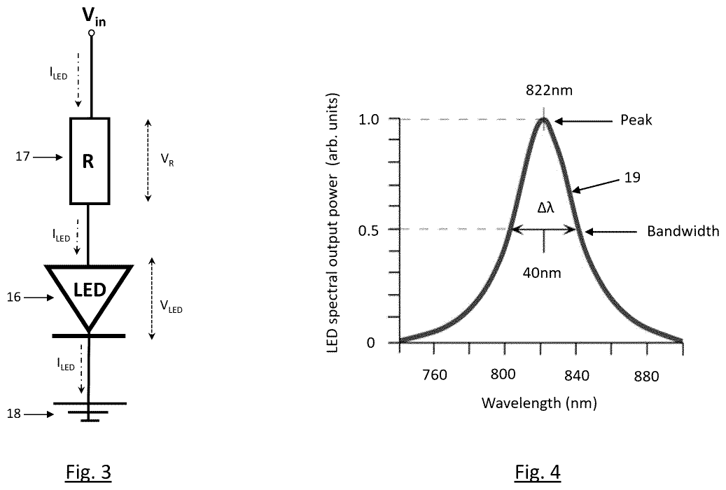

FIG. 3 shows a schematic diagram of a non-thermal light source within the non-thermal light source unit 7 of the random number generator of FIG. 2. In this example, the non-thermal light source comprises a light-emitting diode, LED, 16 configured to receive a pulse-width modulated DC drive voltage, of amplitude Vᵢₙ, from the power supply and control unit. For example, the Vᵢₙ=3.3V. The LED 16 is connected in series with resistor, R, 17 and both the resistor and the LED are connected between the DC drive voltage input terminal and a ground terminal connection. As a result a drive current I_{LED} flows through both the series resistor 17 and the LED 16 from the drive voltage input terminal to the ground terminal 18. A voltage V_{R} is dropped across the resistor 17 and a voltage V_{LED} is dropped across the LED 16. The purpose of the resistor is to control the current, I_{LED}, that flows. In these circumstances the fluctuations in the current are determined by thermal (Johnson) noise in the resistor. However, it can be shown that provided that the voltage, V_{R}, dropped across the resistor is greater than 2k_{B}T/e, then the fluctuations in the drive current, I_{LED}, are below the shot-noise level. Here, T is the temperature of the resistor, k_{B} is Boltzmann's constant and e is the absolute value of the electron charge. The value of this quantity 2k_{B}T/e≈50 mV at room temperature. Accordingly, the resistance value of the resistor 17 is of the order of kΩ (e.g., R=1.2kΩ) meaning that for a current I_{LED}=1 mA into the LED, V_{R}=I_{LED}R=1.2V. This is far in excess of 2k_{B}T/e, meaning that the fluctuations in the drive current, I_{LED}, are below the shot-noise level. Consequently, shot-noise fluctuations in the LED drive current are suppressed and will have a negligible influence upon the statistics of the photons 10 generated by the LED. As a result, the quantum uncertainty, ΔU, present in the energy of the field modes may more effectively dominate the temporal variations in the continuous electrical output signal 13 of the photosensor unit 12 for use in generating therefrom one or more quantum random numbers.

The LED 16 may be an AlGaAs LED. FIG. 4 shows the emission spectrum 19 of such an LED at room temperature. The spectrum peaks at a wavelength of 822 nm and has a bandwidth (FWHM) of Δλ=40 nm. It is clearly non-thermal in nature. This also means that each photon 10 generated by the LED will have an energy of [symbol] ω=2.24×10⁻¹⁹ Joules. For a current I_{LED}=1 mA into the LED approximately 6.24×10¹⁵ electrons flow into the LED per second. The LED may typically have an efficiency of the order of 95% which means that the majority of electrons will be converted into photons 10. Alternatively, in other embodiments, the non-thermal light source may comprise a laser diode or other laser, instead of an LED.

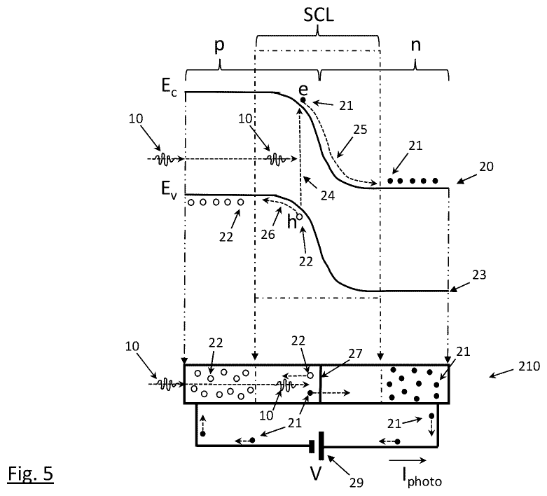

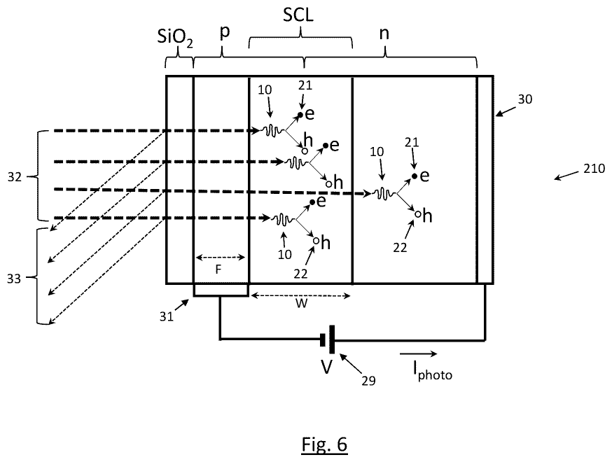

FIGS. 5 and 6 schematically illustrate a photosensor within the photosensor unit 12 of the random number generator of FIG. 2. The photosensor is a silicon semiconductor photodiode device comprising a reverse-biased p-n type photodiode 210 (or a phototransistor) having an n-type semiconductor (denoted ‘n’ in FIG. 5) in contact 27 with a p-type semiconductor (denoted ‘p’ in FIG. 5) thereby providing a space charge layer (SCL) or depletion region with a high electric field that separates photogenerated electron-hole pairs. Photogeneration occurs by absorption of an incident photon 10, from the light source 2, inside the SCL. This generates an electron, e, 21 and a hole, h, 22. Both the electron 21 and the hole 22 then fall along their respective potential energy hills (the electrons move 25 along the conduction band potential, E_{c}, 20, and the holes move 26 along the valence band potential, E_{V}, 23). This drift causes a photocurrent, Iₚₕₒₜₒ, in the external circuit of the photosensor, driven by a drive voltage 29 applied to the anode and cathode (30, 31) of the photodiode. Importantly, this photogeneration may take place continuously such that a continuous photocurrent, Iₚₕₒₜₒ, may be produced that is continuous in time throughout a light absorption time interval concurrent with the light emission time interval of the light source 2.

In this way, the photosensor comprises a space charge layer (see ‘SCL’ above) or depletion region for the continuous generation of photoelectrons by the absorption of photons 10, so that the photosensor is able to output photoelectrons as a continuous electrical output signal contemporaneously as the photoelectrons are generated. This permits the continuous sampling of the photons 10 of the electromagnetic field 9 such that the quantum noise present in the photocurrent, Iₚₕₒₜₒ, and the photosensor output voltage 13 generated from that current, may be continuously sampled by the processor unit 14 for generating quantum random numbers.

It is to be noted that this type of image sensor is quite distinct from other types of photosensor such as CCD sensors used in image capture sensor arrays. This is because image capture sensor arrays require the use of a “potential well” at each sensor pixel. This “potential well” is used to trap and collect photoelectrons over extended intervals of time, and then at intermittent times, to empty the collected photoelectrons from the “potential well” thereby creating intermittent signal pulses. This collection process in these “potential well” type sensors effectively destroys the quantum uncertainty, ΔU, present in the energy of the electromagnetic field modes which may otherwise have remained imprinted within the temporal variations of the photo current. There is no possibility of a continuous photocurrent output with temporal variations suitable for use in generating one or more quantum random numbers. The intermittent signal in these “potential well” type sensors prevents the sensor from outputting photoelectrons as a continuous electrical output signal contemporaneously as the photoelectrons are generated. In other words, the current output would be in the form of separate pulses corresponding to those times when the “potential well” was emptied.

FIG. 6 schematically illustrates a photosensor within the photosensor unit 12 of FIG. 5, of the random number generator of FIG. 2. As discussed in reference [1]: Ferrero et al.: “New model for the internal quantum efficiency of photodiodes based on photocurrent analysis”. Applied Optics, vol. 44, No. 2, pp208-216, January 2005, the depletion layer, or SCL, thickness (intrinsic layer) can be selected to optimize the internal quantum efficiency of the photosensor. The inventors have realised that instead of (or in addition to) selecting the thickness of the SCL layer, one may optimise the photons directed into the SCL layer to optimise the internal quantum efficiency of the photodiode.

In particular, consider the structure of a photodiode, schematically represented in FIG. 6. This typically comprises a transparent passivation layer which is often in the form of an anti-reflective glass (SiO₂ layer in FIG. 6). A space-charge layer (SCL) exists within the photodiode and extends through a depth (W) within the photodiode. Between the passivation layer and the proximal part of the SCL exists a ‘front region’ that extends through a depth (F) within the photodiode from the passivation layer to the proximal part of the SCL. As an example, the total depth of the photodiode structure from the front surface of the passivation later to the rear surface of the n-type semiconductor layer may be of the order of 300 μm, with F=0.1 μm and W=20 μm. If photons 10 absorbed by the photodiode 210 create electron-hole pairs within the SCL then the internal quantum efficiency of the photodiode is maximised. This requires that photons 10 from the light source are able to enter the photodiode in sufficient numbers to generate electron-hole pairs, and are also able to transmit into the photodiode to a depth falling within the depth (W) of the SCL before being absorbed and thereby creating an electron-hole pair within the SCL, rather than transmitting to a greater depth and passing beyond the SCL before being absorbed to generate an electron-hole pair outside of the SCL.

Turning to FIG. 6 in more detail, consider light 32 incident upon the outermost surface of the SiO₂ passivation layer. A portion 33 of that incident light is reflected and a portion is transmitted into the photodiode and able to pass through the front region (F) so as to reach the SCL. Of the light that reaches the SCL, a portion of the photons 10 of that light are absorbed by the material of the photodiode and create electron-hole pairs (21, 22) within the SCL. However, another portion of the photons 10 transmit through the SCL and are absorbed by the n-type semiconductor material of the photodiode located behind the SCL and a depth exceeding the sum of the depths of the front region and the SCL (i.e., exceeding F+W). The electron-hole pairs (21, 22) created in this deeper are less likely to contribute to eth photocurrent output, Iₚₕₒₜₒ, of the photodiode.

The probability that an incident photon 10 may reach a given depth within the photodiode before being absorbed and generating an electron-hole pair is dependent upon the absorption coefficient, α(λ), of the semiconductor material of the photodiode, and that absorption coefficient is generally a function of the wavelength, λ, of the photon in question.

Generally, the absorption coefficient, α(λ), of semiconductor materials used in photodiodes (e.g., silicon) increase in value as the wavelength of the photons decreases. This means that photons with shorter wavelengths are more likely to be absorbed by the semiconductor material of the photodiode at shallower depths below the passivation layer, once within the semiconductor material.

This means that the likelihood of a photon passing all the way through the SCL before being absorbed by the semiconductor material at a location beyond the SCL may be reduced if the incident photons are selected to have a wavelength that:
(a) the photodiode is responsive to as defined by the absorption coefficient, α(λ), of semiconductor materials used in photodiodes, and
(b) is selected preferentially to be the shorter wavelengths from amongst the wavelengths that the photodiode is responsive to.

In this way, photons may be selected, according to their energy (wavelength) so as to optimise the internal quantum efficiency of the photodiode.

Accordingly, the light source 7 may be selected such it has an optical output spectrum satisfying conditions (a) and (b). For example, this may be achieved by employing a light source possessing an intrinsic optical output spectrum satisfying these conditions, or by employing broadband light source that satisfies condition (a) but not condition (b), and then applying an optical filtering to intrinsic optical output such that the filtered optical output satisfies condition (b).

Alternatively, the optical filtering may be applied at between the light source and the photodetector, such as by placing a suitable optical filter between the two such that light from the light source that reaches the photodiode must first pass through the optical filter.

The inventors have found that this optimisation of the photons generated by the light source is not only beneficial in increasing the internal quantum efficiency, IQE, of the photodiode, but that it is also particularly effective at enhancing the amount of quantum noise present within the continuous electrical output signal 13 generated by the photosensor 12 for use in generating quantum random numbers. In particular, with reference to Eq. 18 discussed above, for a field mode containing an average of n photons, 10, each of optical frequency ω, an uncertainty, ΔU, is present in the energy of the field modes according to:

$$Δ U ≡ {〈 {( Δ U )}^{2} 〉}^{\frac{1}{2}} = ℏ ω \sqrt{n}$$

This means that the uncertainty, ΔU, increases in direct proportion to the energy of the photons 10 absorbed by the SCL of the photodiode. This means that photons with shorter wavelengths are more effective at generating quantum noise. This is a very beneficial synergy with the observation that photons 10 of shorter wavelengths are also more efficiently absorbed by semiconductor materials used in photodiodes resulting in an improved internal quantum efficiency, IQE, which in turn further improves the ability of the photosensor to faithfully imprint quantum noise from the electromagnetic field 9 into the continuous electrical output signal 13 generated by the photosensor 12 for use in generating quantum random numbers.

It is noted that application of filtering to the intrinsic optical output spectrum of a light source, such as an LED or the like, will reduce the number of photons, n, (i.e., the intensity of light) incident upon the photodiode. As can be seen in Eq. 18, the uncertainty, ΔU, is present in the energy of the field modes would then fall according to \sqrt{n}. However, if the intensity of the optical output is increased to ensure that the number of photons, n, (i.e., the intensity of light) is restored to a suitable value, then the benefits of increased quantum noise are achieved. The inventors have found that this is particularly effective in generating increased amounts of quantum noise in the continuous electrical output signal 13 generated by the photosensor 12 for use in generating quantum random numbers. It is also a relatively low-cost way to achieve this improvement.

Accordingly, the random number generator preferably comprises an optical filter (see item 420 of FIG. 8) configured to receive light (i.e., photons 10) from the light source (e.g., LED 16) and to transmit only a portion of the received light to the photosensor for use in generating said continuous electrical output signal. The photosensor (e.g., photodiode 47) is responsive to light of wavelengths falling within a predetermined range of wavelengths (e.g., as defined by the spectrum of an absorption coefficient, α(ζ), of semiconductor materials used in photosensor), and the optical filter defines a spectral transmission characteristic (i.e., a transmission spectral band) configured to preferentially transmit light from the light source with wavelengths shorter than a wavelength defining the middle of the predetermined range of wavelengths (e.g., the spectrum of an absorption coefficient, α(λ)).

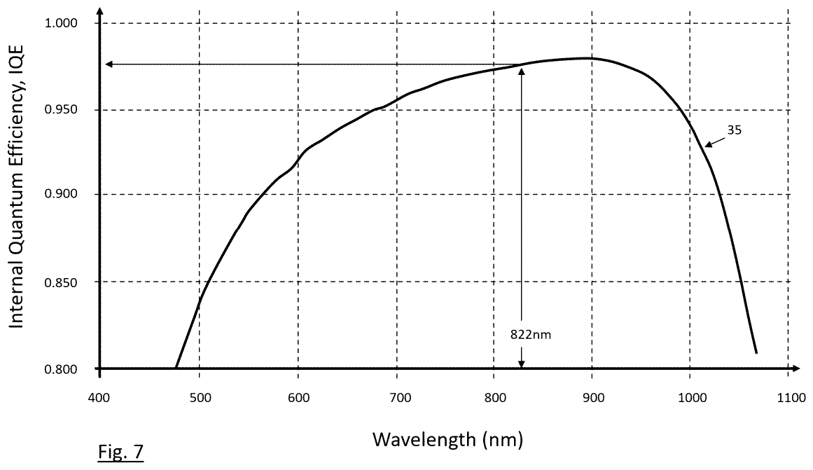

As discussed in reference [2]: Bazkir: “Quantum efficiency determination of unbiased silicon photodiode and photodiode based trap detectors”, Ren. Adv. Mater. Sci. 21 (2009) 90-98, the measured internal quantum efficiency of silicon photodiodes typically exceeds 0.8 for photons of wavelengths from about 450 nm to about 1050 nm. Referring to FIG. 7, this shows a diagram of the spectrum 35 of internal quantum efficiency, IQE, of the photosensor of the type shown in FIG. 5, as a function of the wavelength of illuminating light. The photosensor has an internal quantum efficiency, IQE, of about 0.97 in respect of photons emitted by the light source (of wavelength centred upon 822 nm). This IQE value far exceeds the preferred minimum value of 0.5 in respect of photons emitted by the light source. This means that the statistics of variations in the photocurrent Iₚₕₒₜₒ of the photodiode, and the output voltage signal derived from that, are able to faithfully reproduce the quantum uncertainty in the modes of the electromagnetic field 9.

The optical filter 420 in conjunction with the photosensor may have a low external quantum efficiency, EQE, e.g., of less than 0.5 in respect of photons emitted by the light source. The inventors have found that, due to the above considerations, even what the external quantum efficiency is as low as 0.25 in these circumstances, the enhancements in internal quantum efficiency, IQE, of the photodiode and quantum noise enhancement, provide beneficial results.

The light source unit 7 and the photosensor unit 12 are provided within a photonic module 42 which may be an integrated chip or other integrated module or unit. This is illustrated in detail in FIG. 8. The module comprises an opaque enclosure 41 containing the light source 16 in the form of an LED and the photosensor 47 in the form of a photodiode, optionally together with an optical filter as noted above. The opaque enclosure 34 is opaque to all wavelengths of light that the photosensor 47 is photosensitive to (e.g., as defined by the spectrum of an absorption coefficient, α(λ), of semiconductor materials used in photosensor). In this way, the opaque enclosure optically isolates the photosensor from light sources external to the opaque enclosure 41. This reduces the influence of noise entering the statistics of variations in the photocurrent Iₚₕₒₜₒ of the photodiode originating from classical noise sources (i.e., non-quantum in origin). The module also comprises a resistor, R, 17 connected in series with the LED between the power input port 46 of the module, configured for receiving the PWM drive voltage signal Vᵢₙ, and a ground terminal 45 of the module, as noted with reference to FIG. 3. A capacitor 33 is also connected in parallel connection across both the series resistor 17 and the LED, with the electrodes of the capacitor being connected to the power input port 46 of the module and the ground terminal 45. For example, the capacitor 33 may have a capacitance of 10 μF and may be configured to remove high frequency noise from input power supply signal, namely PWM drive voltage signal Vᵢₙ.

The cathode pf the photodiode 47 is connected to the non-inverting input of a signal amplifier (48, 49) whereas the anode of the photodiode is connected to the inverting input port of the signal amplifier. The amplifier is configured to amplify the continuous electrical output signal from the photodiode 47 and to output the amplified continuous electrical output signal at a signal output port 54 of the module as a voltage signal (Vₒᵤₜ). The amplifier (48, 49) includes a differential amplifier unit 48 with inverting and non-inverting input ports connected to the photodiode as noted above, and an output port connected to the input port of a Schottky-clamped transistor 49. The signal processor 14 is arranged to receive the voltage signals and to determine the temporal variations as temporal variations in the amplified continuous electrical output signal (Vₒᵤₜ).

The photonic module 42 is configured to deliver the amplified continuous electrical output signal (Vₒᵤₜ) to the signal processor 14 in an unfiltered form and the signal processor then generates one or more quantum random numbers from the unfiltered continuous electrical output signal. As a result, no filtering elements (e.g., capacitors) are present on the Vₒᵤₜ line to ensure that no deliberate smoothing of the output signal occurs which might otherwise remove noise. Of course, it is noise is this invention is interested in.

A smoothing capacitor 51 is connected between the power supply, V_{cc}, of the amplifier 48 and the ground terminal 45 of the photonic module 42. This may be used to remove high frequency noise from power supply V_{cc} of the amplifier 48. It may have a capacitance of, for example, about 0.1 μF. A 3.3 kΩ resistor 53 is positioned in series connection between the power supply, V_{cc}, of the amplifier 48 and the signal output port 54 (Vₒᵤₜ). The power supply, V_{cc}, of the amplifier 48 as connected to the load provided by the 3.3 kΩ resistor 53, provides a completed circuit for a Schottky-clamped transistor 49 which is configured to receive the amplified electrical signal output by the amplifier and which provides the amplified continuous electrical output signal (Vₒᵤₜ) as its output.

The use of a Schottky-clamped transistor 49 permits rapid amplifier operation which, therefore, is better able to accurately amplify rapid temporal variations within the signal from the photodiode 47 that it is configured to amplify. In this sense, the amplifier is better able to faithfully ample quantum noise from the electromagnetic field 9 that is imprinted upon the photodiode output signal.

In general, it is preferable to provide a device that has a suitably low propagation time delay. The benefit of a providing a suitably low propagation time delay is that this allows one to take more rapid digital samples of the analogue photosensor signal and that then means that the digitised signal is less likely to ‘miss’ quantum noise through being too ‘coarse’.

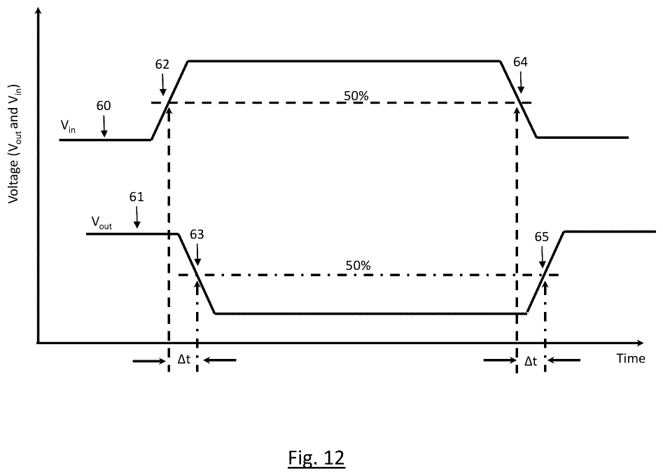

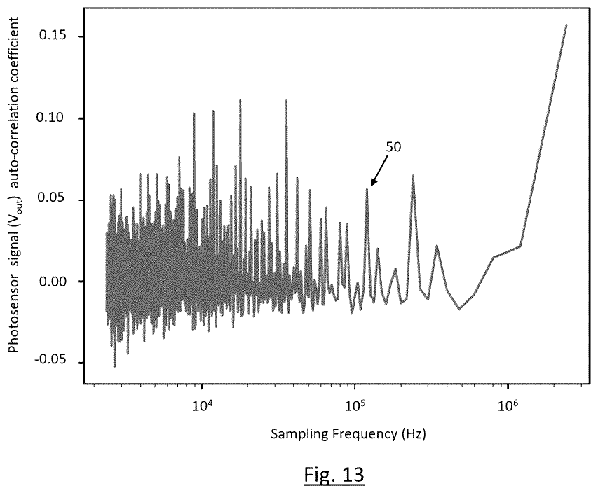

By providing a suitably low “propagation time delay” in an amplifier, this means that the photodiode 47 is able to respond vary quickly to variations in the optical intensity of the electromagnetic field 9, such as may be caused by quantum noise. Referring to FIG. 12, this rapid responsivity may be characterised in terms of the “propagation time delay” of the photodiode which is may be measured in terms of the time delay (Δt) required for a step-change to occur in the photodiode output signal, Vₒᵤₜ, 61 in response to a corresponding step-change in the LED drive signal, Vᵢₙ, 60 as is schematically shown in FIG. 12. The “propagation time delay” may be defined as the time delay between the point in time when the LED drive signal, Vᵢₙ, achieves 50% of the step-change transition (62, 64) during the performance of that step-change, and the point in time when the photodiode output signal, Vₒᵤₜ, achieves 50% of the step-change transition (63, 65) during the performance of its corresponding step-change. Preferably the value of this “propagation time delay” (Δt) is within the range: 0.5 ns≤Δt≤100 ns.

It has been found that when the “propagation time delay” (Δt) falls within this range, the value of the autocorrelation coefficient of a digitised form of amplified continuous electrical output signal (Vₒᵤₜ) is found to be negligibly small when digitised at sampling rates extending across a wide range of sampling frequencies extending up to about 1 Mhz sampling rate. This is shown graphically in FIG. 13 in the form of the autocorrelation coefficient of a digitised electrical output signal (Vₒᵤₜ) when calculated using digitised signals sampled at a range of sampling frequencies. It can be seen that the auto-correlation coefficient is structureless and fluctuates randomly about a value of zero across a wide range of sampling frequencies extending up to about 1 Mhz sampling rate. This illustrates that the digitised electrical output signal (Vₒᵤₜ) remains substantially free of bias or regular patterns (i.e., is random in nature) across these sampling rates and that, therefore, the sampling rates are able to extract the quantum noise in a digital form suitable for digital processing to generate a quantum random number.

It is to be noted that the use of a Schottky-clamped transistor as part of the amplifier within the photonic module 42, described herein, is just one example of how one may achieve this result and the invention is not intended to be limited to this example. There are other ways of achieving a suitably low propagation time delay in an amplifier, as would be readily available and apparent to the skilled person. For example, a Schottky-clamped transistor may be unnecessary if the photodiode 47 is replaced with a fast-response phototransistor. In other words, the use of a Schottky-clamped transistor 49 as part of the amplifier within the photonic module 42 described herein, is optional. However, to allow a better understanding of the present example of the invention, employing a Schottky-clamped transistor for these reasons, the following explanations are given. A saturated transistor may accumulate a stored charge in the base of the transistor. The stored charge causes problems when the transistor needs to be switched from on to off: while the charge is present, the transistor is on; all the charge must be removed before the transistor will turn off. Removing the charge takes time and so the result of saturation is a delay between the applied turn-off input at the base of the transistor and the voltage swing at the collector. This storage time accounts for a significant portion of the propagation delay. This storage time can be reduced, and propagation delay can therefore also be reduced, by preventing the transistor from saturating. The Schottky-clamped transistor 49 prevents saturation. Schottky clamping is achieved by placing a Schottky diode between the base and collector of the transistor. As the transistor approaches saturation, the Schottky diode starts to conduct and shunts current from the base of the transistor into the collector of the transistor before the transistor can saturate. The resulting transistor, 49, which does not saturate, is a Schottky transistor in this sense.

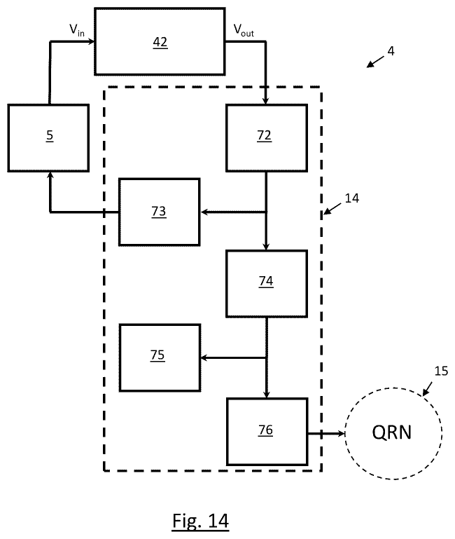

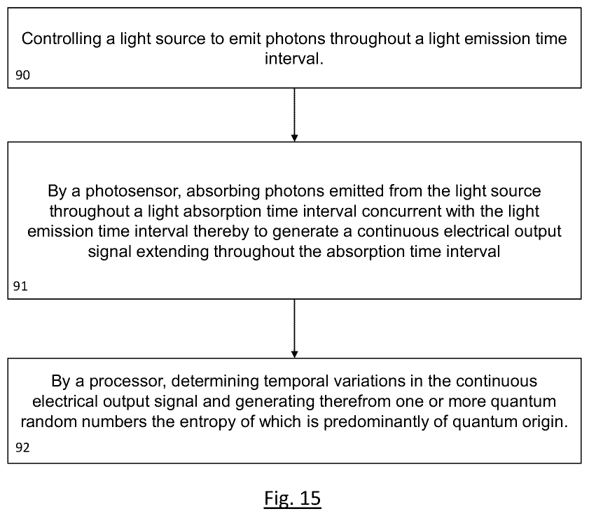

The processor unit 14 is configured to receive the output voltage signal 13 and to convert it into a digital signal. For this purpose, the processor unit comprises an analogue-to-digital converter unit (see item 72 of FIG. 14) for receiving the continuous electrical output in an analogue form and for converting the continuous electrical output into a digital representation comprising a plurality of bits. The processor is configured to generate the quantum random numbers using a sub-set of the plurality bits which excludes at least the most significant bit of the digital representation and includes at least the least significant bit of the digital representation. For the avoidance of doubt, the terms “least significant bit” used herein is intended to have its normal mathematical meaning. In a binary number, the bit furthest to the left is called the most significant bit (‘msb’) and the bit furthest to the right is called the least significant bit (‘lsb’). Bits a sub-set of bits closest to the right, and including the right-most but, are a sub-set of least significant bits within this meaning. It has been found that the quantum noise that resides within the electromagnetic field 9 is conveyed accurately and reliably by the variations in the component parts of the continuous electrical output signal 13 that are represented by the least significant bit of that signal, in a digital representation, or as represented by a sub-group of several of the bits of increasing significance starting from the least significant bit. The least significant bit, or sub-group of least significant bits, represent the smaller (or smallest) component parts of the digital signal and are found to accurately convey the quantum noise extracted from the electromagnetic field 9 by the photosensor unit 12, without the need to use signal bits of higher significance. The digital representation comprises N bits, and the sub-set of the plurality bits excludes M of the most significant bits of the digital representation and includes L of the least significant bits of the digital representation, wherein N, M and L are positive integers and N=M+L.

The variation in the continuous electrical output signal 13 is quantified by the standard deviation, and this quantity is proportional to the square root of the value of the continuous electrical output signal (SD=\sqrt{Vₒᵤₜ}), as noted above and with reference to FIG. 10. This means that if the continuous electrical output signal 13 is represented digitally by N bits then the standard deviation is represented by N/2 bits. Suitable values for M and L in respect of the continuous electrical output signal represented by N bits, are L=N/2 and M=N/2. For example, N=10 and therefore a sub-group of five (i.e., L=5) of the least significant bits of the continuous electrical output signal are selected by the processor for use in generating quantum random numbers. This selection excludes the remaining five (i.e., M=5) most significant bits of the continuous electrical output signal 13.

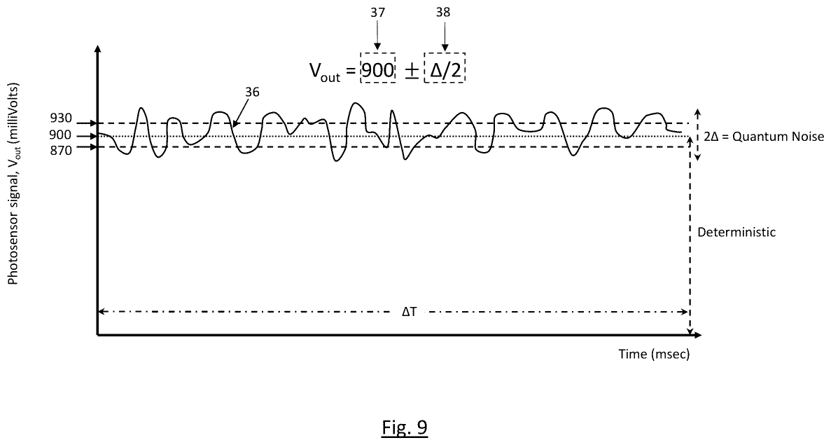

As an illustrative example, consider a schematic representation of a continuous electrical output signal as illustrated in FIG. 9. This signal has a value 36 that fluctuates randomly and continuously throughout the light absorption time interval, ΔT, of the photosensor unit 12, between a lower value of about Vₒᵤₜ=870 millivolts and an upper value of about Vₒᵤₜ=930 millivolts. The signal has a mean value 37 of 900 millivolts upon which is added 38 a randomly fluctuating value, ±Δ, which carries quantum noise and which creates the Standard Deviation (SD) of the signal values throughout the light absorption time interval, ΔT, and is caused by quantum noise in the electromagnetic field 9. The Standard Deviation is SD=30 millivolts which means that for the majority of the time, the value 36 of the signal fluctuates randomly within one Standard Deviation of its mean value.

Consider the digital representation of this signal. First consider the digital representation of the mean value of the signal, which is 900 millivolts: 900→1110000100 millivolts in binary. This binary number has 10 bits (i.e., N=10). The Standard Deviation of the signal is equal to the square root of the mean value of the signal, in accordance with Poisson statistics as discussed above: SD=\sqrt{900}=30→11110 in binary. This binary number has 5 bits, and the variations in the signal that create the value of the Standard Deviation are concentrated in the 5 least significant bits (i.e., L=5) of the fluctuating signal value 36 and these are used in generating quantum random numbers. Conversely, the remaining five (i.e., M=5) most significant bits of the fluctuating signal value 36 are not used in generating quantum random numbers (e.g., the five rightmost bits of the number binary representation of 900 millivolts, with emphasis added: 1110000100).

In addition, or as an alternative, the processor unit 14 may be configured to calculate a time average value of the individual bits corresponding to different respective bit position within the digital representation of the continuous electrical output signal. The time-averaging may comprise calculating the average of a plurality of the instantaneous bit values, for a given bit position, over an interval of time equal to (or residing within) the aforementioned light absorption time interval. The processor unit 14 may compare the time-averaged values to a pre-set reference value of 0.5 and may generate the quantum random numbers using only those bits corresponding to the bit positions for which the time-averaged value does not exceed the reference bit value of 0.5 by more than a pre-set difference value of 0.05.

If a bit value of 1 is equally as likely as a bit value of 0 during the time interval over which averaging took place, then the time-averaged bit value will be sufficiently close to 0.5 to indicate that the instantaneous bit value is random in nature. However, if the time-averaged bit value is less than 0.45 then a bit value of 1 is less likely than a bit value of 0 then this would be taken to indicate that the continuous electrical output signal possesses a bias. Alternatively, if the time-averaged bit value is greater than 0.55 then a bit value of 1 is more likely than a bit value of 0 and this would also be taken to indicate that the continuous electrical output signal possesses a bias. Either way, the data is not truly random. The processor unit 14 may be configured to calculate the time-averaged bit value of all bit positions corresponding to only the sub-set of the plurality bits of the digital representation of the continuous electrical output signal, which excludes M of the most significant bits, or the processor may be configured to calculate the time-averaged bit value of all bit positions corresponding to all bits of the digital representation of the continuous electrical output signal. In this way, bits may be excluded from use in generating the quantum random number based on this time-averaging process either in addition to excluding M of the most significant bits, or as an alternative to that.

Thus, in summary, FIG. 9 shows a schematic diagram of an analogue voltage output signal, (Vₒᵤₜ), corresponding to the photocurrent (Iₚₕₒₜₒ) generated by the photodetector 210 of FIG. 5. The voltage output is generated by the amplifier (48, 49) via the photocurrent Iₚₕₒₜₒ of the photodiode 47 of FIG. 8. It can be seen that this continuous electrical output signal extends throughout the absorption time interval, ΔT, and comprises signal components that can be ascribed to deterministic sources and to quantum noise. As noted above, the value 36 of the signal comprises a steady mean signal level upon which random fluctuations, of randomly varying size Δ, are added. These random fluctuations cause the signal to fluctuate between values a little above and a little below the mean value according to a Standard Deviation (SD). The causes of the steady mean signal level are deterministic, whereas the source of the random fluctuations, Δ, are quantum in origin as noted above. The mean signal level may be represented digitally by a sub-set of the most significant bits of the digital value of that signal. Conversely, the random fluctuations, Δ, of quantum origin may be represented by the least significant bit or a selected number (e.g., a sub-set) of the least significant bits representing the randomly changing values of “Δ”.

The processor unit 14 also functions as a controller (see item 73 of FIG. 14) configured to control the light source, via the power supply and control unit 5, to adjust the intensity of light emitted from the light source to maintain the temporal variations in the continuous electrical output signal to be within a pre-set range. The pre-set range is a pre-set range of the value of Variance of the temporal variations. The pre-set range in respect of a given continuous electrical output signal is a range centred upon a median Variance which is substantially equal to the value of the continuous electrical output signal. FIG. 10 shows a graph of the relationship between the value of the output voltage signal from the photosensor unit and the value of the Standard Deviation, SD, of that signal. Of course, the Standard Deviation is related to the Variance, Var, by the simple relation:

SD=\sqrt{Var}

As noted above, the Variance of the output voltage signal from the photosensor unit is expected to be equal to the value of the output voltage signal itself, such that:

Var=Vₒᵤₜ

The result is that:

SD=\sqrt{Vₒᵤₜ}

This mathematical relation can be clearly seen in the data plotted in FIG. 10, after taking into account the reverse logic output (Vₒᵤₜ) of the photonic module 42 (see Table 1). The measured values 43 of SD are found to approximate very closely the value of \sqrt{Vₒᵤₜ} as indicated by comparison to the positions of corresponding datapoints 40 compliant exactly with the mathematical (theoretical) relation above.

The close agreement extends over a wide range of values of Vₒᵤₜ. At certain low and high values of Vₒᵤₜ, this mathematical relation does not hold but, otherwise, the relation holds to within an approximation defined by a pre-set range of the value of SD that extends between a lower range bounding limit 430 and an upper range bounding limit 431. Those values of Vₒᵤₜ that possess a value of SD not falling within this range are not acceptable output signals. For example, at the lowest values and highest values of Vₒᵤₜ shown in the data plotted in FIG. 10, at about 200 mV and about 3100 mV respectively, the value of SD falls to about SD=5 mV in both cases. It is believed to originate from thermal noise. This occurs when the LED is saturated (Vₒᵤₜ=200 mV) and when it has a very low photon output (Vₒᵤₜ=3100 mV), respectively. The additional amount of SD above this base-line value, arising at intermediate values of Vₒᵤₜ and having SD>5 mV is believed to arise predominantly from quantum noise.

The processor unit 14 of the random number generator is preferably configured to implement a condition, to within a pre-set margin of acceptable error, that the measured value of the Variance (or SD) in the statistics of the photoelectron current (and therefore of Vₒᵤₜ) is equal to the measured value of the Mean (or \sqrt{Mean}) in the statistics of the photoelectron current (and therefore of Vₒᵤₜ) which mirrors the photon statistics. The pre-set margin of error may be a pre-set amount or a pre-set range. It is a margin within which the processor unit accepts that the above condition is deemed to be satisfied, for practical purposes. For example, the condition implemented by the random number generator may be: Variance=Mean±range (or SD=√(Mean)±½range). For example, the value of the quantity “½range” may be a value of up to 10% of the associated value of SD. In examples of the invention, the value of SD may be about 30-50 mV, such that a 10% of that value will be “½range”≈3 mV-5 mV. As an example, the pre-set amount or margin may correspond ±½ of the “range” 432 shown in FIG. 10, after taking into account the reverse logic output (Vₒᵤₜ) of the photonic module 42 (see Table 1).

The processor unit 14 is configured to detect when the variance (i.e., the SD) of the temporal variations in the continuous electrical output signal Vₒᵤₜ are not within this pre-set range of the value of Variance. It is configured to then adjust the intensity of the light emitted from the light source to one or more intensity values within a pre-set range of intensity values and if the variance (i.e., the SD) of the temporal variations in the continuous electrical output signal Vₒᵤₜ remain not within the pre-set range 432 of the value of Variance in response to the adjusted intensity of the light emitted from the light source, then the processor unit 14 determines that a fault is present and it outputs a fault warning message. This fault warning message may be output as a message in digital form to a computer operating the random number generator, and/or as an audio or visual message or signal to a user.

In addition, the processor unit 14, via the power supply and control unit 5, is configured to control the light source to vary the intensity of light illuminating the photosensor successively with each one of a plurality of different intensities of light therewith to generate a respective plurality of continuous electrical output signals, Vₒᵤₜ, in response to the different respective intensities of light. The processor unit 14 is configured to then determine the Variance of each of the plurality of continuous electrical output signals, Vₒᵤₜ, thereby providing a plurality of variance (i.e., SD) values. The processor unit 14 then selects the largest variance value from amongst the plurality of Variance values within the pre-set range 432 of the value of Variance. Subsequently, the processor unit 14, via the power supply and control unit 5, is arranged to control the light source to illuminate the photosensor with the intensity of light corresponding to the selected Variance.

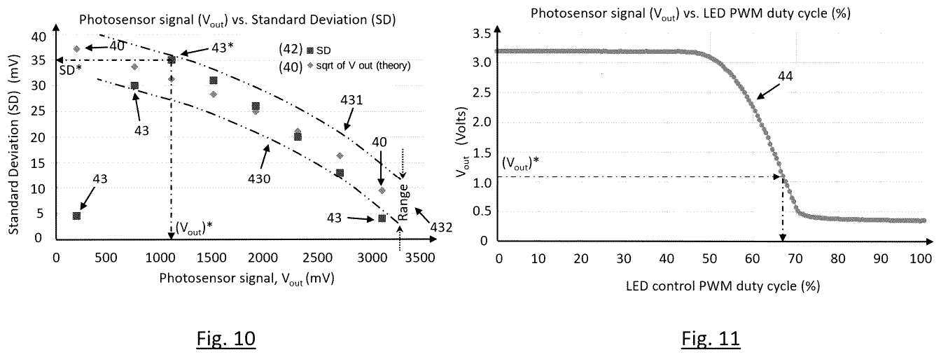

To illustrate the effect of this process, FIG. 10 indicates a selected value 43* of the electrical output signal values, (Vₒᵤₜ)*, possessing the largest Variance value (SD*) and which also satisfies the condition of falling within the range 432 of acceptable Variance values. The processor unit 14, via the power supply and control unit 5, then adjusts the PWM duty cycle applied to the LED 16 of the light source 7 such that the selected value 43* of the electrical output signals, (Vₒᵤₜ)*, is achieved and maintained. FIG. 11 illustrates the effect that varying the PWM duty cycle has upon the value of the electrical output signal 44, Vₒᵤₜ. In this example, a value of (Vₒᵤₜ)*=1.1v is achieved by a duty cycle value of about 67%. Of course, it is to be understood that the example shown in FIG. 11 is merely one example, and other PWM duty cycles may be more appropriate depending on the performance of the light source used (e.g., LED performance) and depending on the performance of the photosensor used. For example, a PWM duty cycle of less than 67% or more than 67% (e.g., about 80%) may be appropriate depending on circumstances. Note that because of the nature of the connection between the photodiode 47 and the amplifier (48, 49), the Truth Table 1, below, of the photonic module 42 is a reverse logic form as shown below:

TABLE 1
Truth

| LED | Output |
|---|---|
| Off | High |
| On | Low |

As a result, an increase on the PWM duty cycle of the LED drive signal results in a reduction in the value of the electrical output signal 44, Vₒᵤₜ, as seen in FIG. 11. Of course, this is simply one example of an implementation of the invention in which reverse logic happens to be present. However, it is to be understood that other amplifier circuit arrangements are possible, as would be readily available to the skilled person, which do not lead to a reverse logic.

FIG. 15 sets out steps in a method for generating a random number according to the invention. The method comprises the following steps:
(90) controlling a light source to emit photons throughout a light emission time interval;
(91) by a photosensor, absorbing photons emitted from the light source throughout a light absorption time interval concurrent with the light emission time interval thereby to generate a continuous electrical output signal extending throughout the absorption time interval; and
(92) by a processor, calculating temporal variations in the continuous electrical output signal and generating therefrom one or more quantum random numbers the entropy of which is predominantly of quantum origin.

The functions of the random number generator 4 may be divided into separate blocks each assigned to the performance of a particular task. Two of the core tasks are: (1) the provision of an entropy source; and, (2) a postprocessing stage in which processing is applied to a signal from the entropy source bearing entropy. Referring to FIG. 14, there is shown a schematic diagram of the random number generator of FIG. 2 in which parts of the processor unit 14 are shown in more detail, in conjunction with the other component parts of the random number generator 4. The entropy source of the random number generator comprises the photonic module 42 described above which is configured to generate quantum noise in the form of random fluctuations in electromagnetic field energy and to provide a reading of that random noise via a photosensor. In a digital random number generator, such as in the present example, a conversion is required from analogue readings into bit strings. Accordingly, the processor unit 14 of the random number generator 4 comprises an analogue-to-digital converter (ADC) 72 configured to receive the continuous electrical output signal 44, Vₒᵤₜ, to convert it into a digital form, and to output the result.

Measurement and quantization are noisy processes and there may be some contamination in what is called a “raw” bit string(s) generated by the ADC unit 72. This may be so even if the measured quantity is truly random and free from correlations. A first postprocessing unit 74 is configured to receive as input a “raw” bit string(s) output by the ADC unit 72 and to apply thereto a process known as randomness extraction. Randomness extraction is ab operation that transforms the bits from the “raw” sequence into a uniformly-distributed random sequence of bits as output in which the output bit sequence contains most or all of the randomness available in the “raw” input bit sequence. The first postprocessing unit 74 is configured to truncate the received “raw” bit sequence of N bits into a sub-set (or sub-sequence) of bits which excludes at least the most significant bit of the digital representation and includes at least the least significant bit of the digital representation. For example, as noted above, the first postprocessing unit 74 may truncate the received “raw” bit sequence to only the L least significant bits thereby excluding the M most significant bits from the received “raw” bit sequence. For example, L=N/2 and M=L/2. In addition, or as an alternative, the first postprocessing unit 74 may be configured to calculate a time average value of the individual bits corresponding to different respective bit position within the received “raw” bit sequence, as described above, and may then compare the time-averaged values to a pre-set reference value of 0.5 and retain only those bits corresponding to the bit positions for which the time-averaged value does not exceed the reference bit value by more than a pre-set difference value (e.g., of 0.05). Subsequent to the postprocessing described above, the first postprocessing unit 74 is configured to output a postprocessed bit sequence from which a quantum random number may be provided.

If the random number generator 4 produces “raw” bit sequences with negligible bias, then the operations of the first postprocessing unit 74 may be omitted or bypassed, as desired. A practical balance may be struck in choosing an adequate degree of postprocessing. More involved randomness extraction methods usually allow to minimize the amount of random bits that are thrown away, but are slower. The overall bit rate depends on whether the increased production of bits compensates or not for the slower processing circuit or if it is justified to use a faster but more complex hardware to remove biases from the raw bit sequence.

If the postprocessed bit sequence is considered to contain negligible bias, then it may be output directly from the processor unit 14, as a quantum random number (QRN) 15 for output from the quantum random number generator 4. Alternatively, the postprocessed bit sequence output from the first postprocessing unit 74 may be input to a second post-processing unit 76 configured to generate a quantum random number using the received postprocessed bit sequence. Many things can affect the uniform distribution of the “raw” bit sequence output by the ADC unit 72. Environmental factors such as the operating temperature of the photonic module 42, electrical interference and light source/sensor deterioration within the photonic module 42 among others are all contributing factors to the potential introduction of bias. In order to produce a random number comprising bit sequences with uniformly-distributed bit values. The target of postprocessing is to take an input of non-uniform random numbers that, after the post processing, are not only uniform but also able to pass statistical testing suites; only failing a small fraction of times of the order of what is deemed acceptable. It is achieved by combining our quantum sourced “raw” bit sequences with a secondary source of entropy such as a pseudo-random number produced by a pseudo-random number generator (PRNG).

The second post-processing unit 76 is configured to implement this and comprises a PRNG configured to generate pseudo-random numbers, and to use each pseudo-random number in conjunction with a given postprocessed bit sequence from the first postprocessing unit in order to generate a final output quantum random number. The pseudo-random number is used as a ‘seed’ and is combined with the given postprocessed bit sequence such that a pre-set number of bytes selected from the pseudo-random number are combined with same pre-set number of bytes selected from the given postprocessed bit sequence using an XOR logic to produce the output quantum random number. The well-known “XORShift Plus” suite of algorithms may be used to this end, as would be readily available to the skilled person.

An optional third postprocessing unit 75 may be configured to receive the postprocessed bit sequence output from the first postprocessing unit 74, and to apply a desired “health-check” algorithm to that bit sequence. A suitable “health-check” algorithm may be one selected from the NIST suite of such algorithms, as described in detail by reference [3] herein: NIST Special Publication 800-90B: “Recommendation for the Entropy Sources Used for Random Bit Generation” by Turan et al. Examples include, but are not limited to: (a) the “Repetition Count Test” as defined in Section 4.4.1 of reference [3]; (b) the “Adaptive Proportion Test” as defined in Section 4.4.2 of reference [3]. The third postprocessing unit 75 may be configured to output a fault warning message if one or both of these tests are not passed. Another “health-check” algorithm implemented by the third postprocessing unit 75 may be to determine the ratio of the number of “1” bit values to the number of “0” bit values within the postprocessed bit sequence to determine whether the ratio has a value sufficiently close to 1.0 (i.e., bit values “1” and equally as common as bit values “0” within the bit sequence) and to output a fault warning message if this condition is not met. Being sufficiently close to 1.0 may refer to having a value that differs from 1.0 by less than 5%, for example.

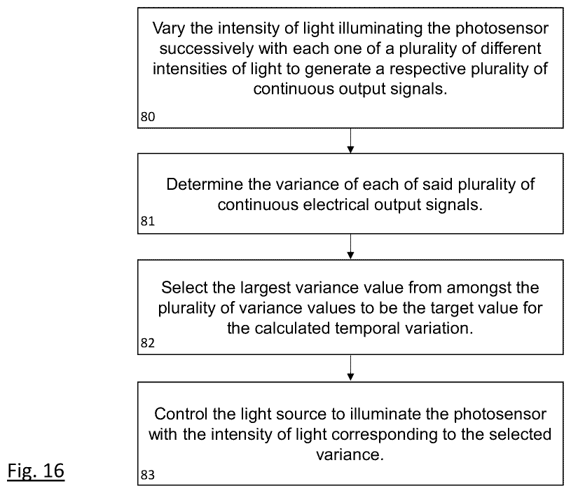

The processor unit 14 also comprises an autocalibration unit 73 which is configured to implement a method for controlling the generating of a random number according to the invention. The autocalibration unit 73 is configured to monitor (e.g., periodically sample) the value of the Variance (or Standard Deviation) of the continuous electrical output signals input to the processor unit 14 from the photonic module 42, and to control the light source 7 within the photonic module so as to vary the intensity of light illuminating the photosensor thereby to maintain the Variance (or Standard Deviation) value at a pre-set target Variance (or Standard Deviation) value. The pre-set target Variance (or Standard Deviation) value may correspond to the ‘largest’ Variance (or Standard Deviation) value from amongst the sampled values. To this end, the processor unit 14 may implement the following steps shown in FIG. 16:
(80) controlling the light source to vary the intensity of light illuminating the photosensor successively with each one of a plurality of different intensities of light and therewith generating a respective plurality of said continuous electrical output signals in response to the different respective intensities of light;
(81) determining the variance of each of said plurality of continuous electrical output signals, thereby providing a plurality of variance values;
(82) selecting the largest variance value from amongst the plurality of variance values within said pre-set range of the value of variance; and
(83) controlling the light source to illuminate the photosensor with the intensity of light corresponding to the selected variance.

The step of adjusting the intensity of the light emitted from the light source may be performed by a process including adjusting the power suppled to the light source via the power supply and control unit 5. This may include adjusting the duty cycle of the pulse-width modulation (PWM) applied by the power supply and control unit 5. In this way, the autocalibration unit 73 may find the appropriate value(s) of the control parameter(s) of the light source (e.g., the PWM duty cycle value) necessary to achieve the intensity of light emission from the light source required to produce the largest Variance (or Standard Deviation) of the temporal variations consistent with quantum noise. Therefore, the greater is the measured maximum Variance (or Standard Deviation) the greater is the quantum noise content.

The power supply and control unit 5 is configured to generate a digital power supply control signal conveying the PWM control signal in a digital form and comprises a digital-to-analogue converter (DAC) arranged to receive the PWM control signal in the digital form and to convert the received signal into an analogue form, Vᵢₙ, for input to the photonic module 42.

As an alternative, the power supply and control unit 5 may be configured to generate a digital power supply control signal using the DAC to control power output signal value, Vᵢₙ, instead of using a PWM signal with adjustable duty cycle. In this alternative, the autocalibration unit 73 may be configured such that the step of adjusting the intensity of the light emitted from the light source is performed by a process including controlling the DAC to adjust the power suppled to the light source via the power supply and control unit 5. This may include adjusting the amplitude of the analogue signal, Vᵢₙ, output by the DAC of the power supply and control unit 5. In this way, the autocalibration unit 73 may find the appropriate value(s) of the control parameter(s) of the light source (e.g., the DAC amplitude value) necessary to achieve the intensity of light emission from the light source required to produce the largest Variance (or Standard Deviation) of the temporal variations consistent with quantum noise.

A computer or a processor or a microprocessor comprising a computer program may be configured to implement these methods when executed on the computer or the processor or the microprocessor.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### References

A number of publications are cited above in order to more fully describe and disclose the invention and the state of the art to which the invention pertains. Full citations for these references are provided below. The entirety of each of these references is incorporated herein.
[1] Ferrero et al.: “New model for the internal quantum efficiency of photodiodes based on photocurrent analysis”. Applied Optics, vol. 44, No. 2, pp208-216, January 2005.
[2] Bazkir: “Quantum efficiency determination of unbiased silicon photodiode and photodiode based trap detectors”, Ren. Adv. Mater. Sci. 21 (2009) 90-98.
[3] NIST Special Publication 800-90B: “Recommendation for the Entropy Sources Used for Random Bit Generation” by Turan et al.

1. A random number generator comprising:
a light source configured to emit photons throughout a light emission time interval;
a photosensor configured to absorb photons emitted from the light source throughout a light absorption time interval concurrent with the light emission time interval thereby to generate a continuous electrical output signal extending throughout the absorption time interval; and
a processor configured to determine temporal variations in the continuous electrical output signal and to generate therefrom one or more quantum random numbers.

2. A random number generator according to claim 1 comprising a light source drive circuit configured to supply a drive current into the light source wherein the light source drive circuit comprises an electrically resistive circuit component connected in series with the light source wherein the light source drive circuit is configured to apply a voltage across the electrically resistive circuit component sufficient to provide a voltage at the light source sufficient to suppress shot noise.

3. A random number generator according to claim 1 wherein the photosensor has an internal quantum efficiency, IQE, exceeding 0.5 in respect of photons emitted by the light source.

4. A random number generator according to claim 1 comprising an optical filter configured to receive light from the light source and to transmit only a portion of the received light to the photosensor for use in generating said continuous electrical output signal, wherein the photosensor is responsive to light of wavelengths falling within a predetermined range of wavelengths, and the optical filter defines a spectral transmission characteristic configured to preferentially transmit light from the light source with wavelengths shorter than a wavelength defining the middle of said predetermined range of wavelengths.

5. A random number generator according to claim 4 wherein the optical filter in conjunction with the photosensor has an external quantum efficiency, EQE, of less than 0.5 in respect of photons emitted by the light source.

6. A random number generator according to claim 1 comprising an analogue-to-digital converter unit for receiving the continuous electrical output in an analogue form and for converting the continuous electrical output into a digital representation comprising a plurality of bits, wherein the processor is configured to generate said quantum random numbers using a sub-set of the plurality bits which excludes at least the most significant bit of the digital representation and includes at least the least significant bit of the digital representation.

7. A random number generator according to claim 6 wherein the digital representation comprises N bits, and the sub-set of the plurality bits excludes M of the most significant bits of the digital representation and includes L of the least significant bits of the digital representation, wherein N, M and L are positive integers and N=M+L.

8. A random number generator according to claim 1 comprising a controller configured to control the light source to adjust the intensity of light emitted from the light source to maintain a condition that a value of the variance of said temporal variations in the continuous electrical output signal differs from a value of the mean thereof by not more than a pre-set amount.

9. A random number generator according to claim 1 comprising a controller configured to control the light source to adjust the intensity of light emitted from the light source to maintain said temporal variations in the continuous electrical output signal to be within a pre-set range;
wherein the pre-set range is a pre-set range of the value of variance of said temporal variations; and
wherein the pre-set range in respect of a given continuous electrical output signal is a range centred upon a median variance which is substantially equal to the value of the continuous electrical output signal.

10. A random number generator according to claim 9 wherein the controller is further configured to:
detect when the variance of said temporal variations in the continuous electrical output signal are not within said pre-set range of the value of variance;
adjust the intensity of the light emitted from the light source to one or more intensity values within a pre-set range of intensity values; and
if the variance of said temporal variations in the continuous electrical output signal remain not within said pre-set range of the value of variance in response to the adjusted intensity of the light emitted from the light source, to determine that a fault is present and to output a fault warning message.

11. A random number generator according to claim 9 wherein the controller is configured to:
control the light source to vary the intensity of light illuminating the photosensor successively with each one of a plurality of different intensities of light therewith to generate a respective plurality of said continuous electrical output signals in response to the different respective intensities of light;
determine the variance of each of said plurality of continuous electrical output signals, thereby providing a plurality of variance values;
select the largest variance value from amongst the plurality of variance values within said pre-set range of the value of variance; and
control the light source to illuminate the photosensor with the intensity of light corresponding to the selected variance.

12. A method for generating a random number comprising:
controlling a light source to emit photons throughout a light emission time interval;
by a photosensor, absorbing photons emitted from the light source throughout a light absorption time interval concurrent with the light emission time interval thereby to generate a continuous electrical output signal extending throughout the absorption time interval; and
by a processor, determining temporal variations in the continuous electrical output signal and generating therefrom one or more quantum random numbers.

13. A method for generating a random number according to claim 12 comprising providing a light source drive circuit and therewith supplying a drive current into the light source wherein the light source drive circuit comprises an electrically resistive circuit component connected in series with the light source wherein the light source drive circuit is configured to apply a voltage across the electrically resistive circuit component sufficient to provide a voltage at the light source sufficient to suppress shot noise.

14. A method for generating a random number according to claim 12 wherein the photosensor has an internal quantum efficiency, IQE, exceeding 0.5 in respect of photons emitted by the light source.

15. A method for generating a random number according to claim 12 comprising:
by an optical filter, receiving light from the light source so as to transmit only a portion of the received light to the photosensor for use in generating said continuous electrical output signal,
wherein the photosensor is responsive to light of wavelengths falling within a predetermined range of wavelengths, and the optical filter defines a spectral transmission characteristic configured to preferentially transmit light from the light source with wavelengths shorter than a wavelength defining the middle of said predetermined range of wavelengths.

16. A method for generating a random number according to claim 15 wherein the optical filter in conjunction with the photosensor has an external quantum efficiency, EQE, of less than 0.5 in respect of photons emitted by the light source.

17. A method for generating a random number according to claim 12 comprising providing an analogue-to-digital converter unit and therewith receiving the continuous electrical output in an analogue form and converting the continuous electrical output into a digital representation comprising a plurality of bits, wherein the method includes, by processor, generating said quantum random numbers using a sub-set of the plurality bits which excludes at least the most significant bit of the digital representation and includes at least the least significant bit of the digital representation.

18. A method for generating a random number according to claim 17 wherein the digital representation comprises N bits, and the sub-set of the plurality bits excludes M of the most significant bits of the digital representation and includes L of the least significant bits of the digital representation, wherein N, M and L are positive integers and N=M+L.

19. A method for generating a random number according to claim 12 comprising controlling the light source to adjust the intensity of light emitted from the light source to maintain a condition that a value of the variance of said temporal variations in the continuous electrical output signal differs from a value of the mean thereof by not more than a pre-set amount.

20. A method for generating a random number according to claim 12 comprising:
controlling the light source to adjust the intensity of light emitted from the light source to maintain said temporal variations in the continuous electrical output signal to be within a pre-set range;
wherein the pre-set range is a pre-set range of the value of variance of said temporal variations; and
wherein the pre-set range in respect of a given continuous electrical output signal is a range centred upon a median variance which is substantially equal to the value of the continuous electrical output signal.

21. A method for generating a random number according to claim 20 comprising:
detecting when the variance of said temporal variations in the continuous electrical output signal are not within said pre-set range of the value of variance;
adjusting the intensity of the light emitted from the light source to one or more intensity values within a pre-set range of intensity values; and
if the variance of said temporal variations in the continuous electrical output signal remain not within said pre-set range of the value of variance in response to the adjusted intensity of the light emitted from the light source, determining that a fault is present and outputting a fault warning message.

22. A method for generating a random number according to claim 20 comprising:
controlling the light source to vary the intensity of light illuminating the photosensor successively with each one of a plurality of different intensities of light and therewith generating a respective plurality of said continuous electrical output signals in response to the different respective intensities of light;
determining the variance of each of said plurality of continuous electrical output signals, thereby providing a plurality of variance values;
selecting the largest variance value from amongst the plurality of variance values within said pre-set range of the value of variance; and
controlling the light source to illuminate the photosensor with the intensity of light corresponding to the selected variance.

23. A computer or a processor or a microprocessor comprising a computer program configured to implement the method according to claim 12 when executed on the computer or the processor or the microprocessor.

24. A computer program product comprising a storage medium containing a computer program configured to implement the method according to claim 12 when executed on a computer or a processor or a microprocessor when programmed according to the computer program.
